(19) United States
(12) Patent Application Publication
(10) Pub. No.: US 2005/0261956 A1
(43) Pub. Date: Nov. 24, 2005

(54) Network-Employing System for Evaluating Anonymous Information in Providing Information on Positions/Help Wanted and Related Information

(75) Inventor: Hirotoshi Kato, Shinjuku-ku, Tokyo (JP)

Correspondence Address: JUDGE PATENT FIRM;RIVIERE SHUKUGAWA 3RD FL., 3-1 WAKAMATSU-CHO, NISHINOMIYA-SHI, HYOGO, 662-0035, JP

(73) Assignee: PA CO., LTD., Shinjuku-ku, Tokyo (JP)

(21) Appl. No.: 10/908,635

(22) Filed: May 20, 2005

(30) Foreign Application Priority Data
May 20, 2004 (JP) JP-2004-151039

(51) Int. Cl. G06F 17/60

(52) U.S. Cl. 705/11; 705/1

(57) ABSTRACT

System enabling evaluation of anonymous information when positions/help wanted information is made anonymously. Specialty sites devoted to positions/help wanted information are established on the Internet, and a system is developed for providing similar information on other sites. Recruiting companies enter recruiting information into the specialty sites, and provide the information on other sites. Responses/interviews, etc. are conducted by job seekers/certification candidates anonymously entering positions-wanted/response information at the specialty site and other sites. On the specialty site, logs of responses, interviews, etc., completed by anonymous job seekers/certification candidates and notices sent by recruiting companies are automatically tallied and displayed, and similar information is provided on the other sites. Recruiting companies can browse anonymous job seekers/certification candidates, make conclusions regarding their skills, and evaluate the anonymous information based on the tallied information. The system features a database for personal information, and a database with résumés etc.

### BACKGROUND OF THE INVENTION

1. Technical Field

The present invention relates to systems employing the Internet or other networks to evaluate anonymous information in providing information on positions/help wanted and other information relevant to such recruiting information.

2. Description of the Related Art

Conventionally, companies have used classified advertisement in print media such as newspapers and job advertisement magazines for offering help-wanted information to job seekers.

More recently, companies have set up their own sites on the Internet and have included recruitment information within those sites for job seekers. In the system for providing recruitment information, a business concern offering employment (“hiring business” hereinafter) posts recruitment information on its own site; job seekers then browse the site via the Internet to get recruitment information, and apply for the job via telephone, e-mail, or other conventional means. Companies screen application materials, conduct interviews, etc. for applicants in determining whether to hire them. These services are done by the company itself; therefore, posting the information on the company's website is cost-free.

Job-placement agencies have also been used for recruiting, while temporary employment agencies have been used to recruit not only permanent employees, but also temporary employees.

The system for recruiting using job-placement agencies is as follows. Companies authorized as fee-charging or free job placement agencies post classified advertisements in newspapers, job advertisement magazines, and other print media to recruit job seekers for registration. The companies screen and interview job seekers and then register them. Among the registered job seekers, the agency selects candidates for the hiring business, and introduces them to the hiring business. A fee is charged for the job-placement service of about 20% to 30% of the annual income of the candidate.

These agencies may also provide scouting services by finding desirable people for the hiring business and recommending them to the company. Job-placement agencies also have set up sites on the Internet for providing information about job placement and registration for job placement to recruit job seekers for registration.

The system for hiring temporary staff using temporary-employment agencies is as follows. Companies authorized as temporary-employment agencies post classified advertisements for registration in newspapers, job advertisement magazines, and other print media to recruit job seekers for registration. The companies screen and interview job seekers and then register them. Among the registered job seekers, the agency selects candidates for the hiring business, and dispatches them to the hiring business. A service charge is assessed for dispatching temporary staff. Temporary-employment agencies also have set up sites on the Internet for providing information about temporary employment and registration for temporary employment to recruit persons to be registered.

Similarly, education-related entities such as high schools, junior colleges, four-year colleges, technical-vocational schools, and other training institutions have used classified advertisements in specialized magazines to provide information about student recruiting to persons seeking to obtain a professional license or other certification. Signboard and advertising on mass media, including TV and radio, have been used to provide information about student recruiting. In addition, these entities have set up their own sites on the Internet, and have put advertisements on the sites to provide information about student recruiting.

The system for student recruiting is as follows.

Education-related entities, including technical-vocational schools and other training institutions, provide information about student recruiting by posting classified advertisements in education-related entity specialized magazines for recruiting students. The mechanism for doing this is to post the recruiting information in a student-recruiting specialty magazine that a publisher issues route the magazine through the publishing company's channels or through book distributors, and are then sold or distributed free of charge at bookstores and other outlets. Finally, persons seeking to obtain professional certification (“certification candidates” hereinafter) acquire the magazine to obtain information about student recruiting; the prospective applicants may request brochures or apply to the school by calling or writing to the education-related entity.

Under the system for providing information about student recruiting by posting advertisements on signboards, classified advertisements are posted on signboards placed in stations, alongside roads, on roofs of buildings, etc. Certification candidates read the signboards, gain information about student recruiting, and request brochures or apply to the school through the education-related entity.

Under the system for providing information about student recruiting by advertising on mass media, including TV and radio, commercials for recruiting students are run on different media; certification candidates see the commercials, gain information about student recruiting, and request brochures or apply to the school through the education-related entity.

In recent years, education-related entities have set up their own sites on the Internet, and put advertisements on their own sites to provide information about student recruiting. Under this system for providing information about student recruiting, the education-related entity posts classified advertisements, etc. on its own site; certification candidates browse the information through the Internet, gain information about student recruiting students, and request brochures or apply to the school by calling or emailing the education-related entity.

However, these conventional means for recruiting have the following disadvantages.

Classified advertisements in newspapers reach all of those who purchase newspapers; therefore, the advertisements do not focus on desired targets. The same problem arises with insertions in newspapers. As for classified advertisements in job advertisement magazines, job-seekers have to purchase the magazine at a bookstore or other location to get the information, and thus, the information is not within easy reach. And since only job seekers purchase these magazines, the information is not available to potential job seekers who are thinking of improving their careers.

The more recent practice of posting classified advertisements for recruiting on individual company websites does not make the information readily accessible, since there are countless websites and job seekers must trawl for information among the sites; thus, the chances are low that the information will reach job seekers.

Regarding job placement using job-placement agencies and recruitment of temporary staff using temporary-employment agencies, such agencies post classified advertisements for registration in newspapers, job advertisement magazines, and other publications to recruit job seekers for registration. This system had the same disadvantages stated above regarding newspaper and job advertisement magazines. As for setting up sites on the Internet, the same disadvantages exist as for hiring businesses that post recruiting information on their own sites.

In sum, conventional means for recruiting students have the following disadvantages.

As for classified advertisements in magazines designed for recruiting students, certification candidates have to purchase the magazines at a bookstore or other location to get the information, and thus, the information not within easy reach. And since only certification candidates purchase theses magazines, the information is not available to potential certification candidates who are thinking of improving their skills.

Classified advertisements on signboards and advertising on mass media such as TV and radio does not focus on the desired targets; therefore, the advertising is less effective despite the high cost.

The more recent practice of posting classified advertisements for recruiting students on company websites does not make the information readily accessible, since there are countless websites and job seekers must trawl for the information among the sites; thus, the possibility is low that the information will reach certification candidates.

To address the above-mentioned disadvantages regarding recruiting, a system for providing information about recruiting at a specialized site on the Internet has been created; in addition, a method has been created for providing information about job placement and temporary employment by job-placement agencies and temporary-employment agencies at the same site.

In the system for providing information about recruiting at the specialized site, a company's advertisement is posted at the site to provide information about the company's recruiting; job seekers at the site browse through the company's advertisement so that they can get the necessary information to apply for a position with the company by entering data in an Application Form at the site, using e-mail, and so on. The company screens application materials and then interviews applicants to decide whether to hire them. Accordingly, the disadvantage of advertisements in newspaper and job advertisement magazines, which must be purchased by job seekers, is removed, because information about recruiting can be gained wherever and whenever a computer terminal is connected to the Internet. In addition, the specialized site provides a large amount of information about recruiting at a single location, which resolves the problem of trawling for information posted on the websites of countless different companies.

Likewise, for job-placement agencies and temporary-employment agencies, the problem of advertising in newspapers and job advertisement magazines, which must be purchased, is resolved. Also, the problem of trawling for information about job placement, temporary employment, and registration on the Internet with the company is resolved.

As a means of recruiting students, a system for providing students with recruiting information at a specialized site on the Internet was created.

In the system for providing recruiting information to students at the specialized site, an education-related entity's advertisement is posted on the site to provide information about student recruiting, and prospective applicants can request a school brochure or complete an application for admission to the education-related entity. Accordingly, the disadvantages of advertisements in magazines, which must be purchased by job seekers, is removed, because information about student recruiting can be gained wherever and whenever a computer terminal is connected to the Internet.

In addition, the specialized site provides a large amount of information about student recruiting at a single site, which resolves the problem of trawling for information posted on the websites of different education-related entities.

However, the above-mentioned specialized sites have the following disadvantages. Regarding the specialized sites for information about job offers and recruiting, because there are increasing numbers of similar sites, competition is increasing as well. These specialized sites must recruit job seekers and permit them to apply for jobs online.

Regarding specialized sites for information about student recruiting, the same disadvantage exists: because there are increasing numbers of similar sites, competition is increasing as well. These specialized sites must recruit certification candidates and permit them to request brochures and apply schools online.

To solve these problems, at the specialized site for information about job offers and recruiting, the company managing the specialized site provides information at other sites with high numbers of visitors, such as portal sites and news sites, in addition to the company's own site, to reach more job seekers and promote more applications. At the same time, the specialized site for information about job offers and recruiting collects e-mail addresses of job seekers to provide information about recruiting by e-mail. Job seekers register resumes and curriculum vitae in advance so that more suitable information can be provided to them using the data on their résumés and curriculum vitae.

And at the specialized site for information about student recruiting, the company managing the specialized site provides information at other sites with high numbers of visitors, such as portal sites and news sites, in addition to the company's own site, to reach more certification candidates, and promote more requests for brochures, applications for courses, and inquiries. At the same time, the specialized site for information about student recruiting collects e-mail addresses of certification candidates to provide information about student recruiting by e-mail. Certification candidates register their targeted certifications, targeted courses, résumés, curriculum vitae, etc., in advance so that more suitable information can be provided to them using that data.

However, though improved over conventional means, the above means also have the following disadvantages.

At the specialized site for information about job offers and recruiting, job seekers have to disclose personal data, including résumés, curriculum vitae, etc., to apply. Thus, it is possible that information may be revealed about individuals who are working for one company while seeking a different job, in spite of their wish not to inform their present employer about their job search.

And even though the security may be assured, personal data is not perfectly safe on the Internet and a person's job-seeking activities may be revealed in some way.

Japanese Unexamined Pat. App. Pub. Nos. H10-232893 and 2000-57213 addresses the above-described problems concerning sites devoted to positions/help wanted information with means whereby job seekers can enter personal information, such as names and addresses, and register résumés and curriculum vitae, yet respond anonymously to the job-offering company without revealing personal data to that company. Furthermore, the references propose systems whereby hiring businesses, in viewing positions-wanted information while remaining anonymous, browse résumés and curriculum vitae and are prompted to respond.

In a system proposed in Japanese Unexamined Pat. App. Pub. No. 2001-357124, job seekers register their personal data, including names, addresses, résumés, and curriculum vitae, and at the same time have the option to take an aptitude test prepared at the Internet site, and register the result. Job seekers can apply anonymously to the hiring business without revealing personal data. Likewise, the hiring business can examine résumés and curriculum vitae anonymously, and can also evaluate the results of applicants' aptitude tests anonymously.

However, the above systems also have disadvantages. The reliability of information from anonymous job seekers may be doubtful. Given the virtual nature of applying for a job via the Internet it may be difficult to determine whether the applicant really exists or whether the information provided by the applicant is correct at the time of application. In order to examine applications more thoroughly, interviews are given to applicants. However, not all applicants are interviewed. Furthermore, at the time of interview, a hiring business must reconfirm the registered personal data, résumés, and curriculum vitae, which costs time and money.

Similarly, at the specialized site for information about student recruiting, certification candidates have to enter and disclose personal data for applying, requesting brochures, and making inquiries. Thus, it is possible that information about a prospective certification applicant's plans may be revealed to other people. And even though security may be assured, personal data is not perfectly safe on the Internet and the applicant's preparation activities may be revealed in some way.

Because requests for brochures and applications for courses are anonymous, it may be difficult to determine whether the applicant really exists or whether the information provided by the applicant is correct. In order to examine requests more thoroughly, confirmation measures via telephone or reapplication may be taken. However, it is time-consuming and costly to contact all applicants and permit them to take the courses.

Meanwhile, on a site devoted to information about job transfers, https://www.ecareerfa.jp, the following service has started. Persons who wish to change careers register a career sheet (curriculum vitae), present it anonymously, and wait for a job provided through a job-placement agency. Based on the data in the career sheet, a job-transfer adviser (consultant) of a job-placement agency seeks out persons who meet conditions presented by recruiting companies, and seeks out information helpful in changing jobs, and sends a scouting mail (message) to the relevant person. The person receives the message and selects a job-transfer adviser to consult. In this system, the service that displays the number of scout emails from job-placement agencies to anonymous persons wishing to change careers began in March, 2004.

The applicant in the present case filed a patent application, Japanese Pat. App. No. 2004-134927, for a system for providing information about job offers and recruiting through a general system, comprising a server for the sites devoted to positions/help wanted information that is connected to network, and various sites connected to network, in which the server has an interface, control system, and database, in which the interface is browsable by personal computer, mobile terminal, etc., and the control system keeps information regarding job offers, recruiting, and related information updated constantly, and provides the information to an interface through a database, and in which sites are provided the equivalent display items of the information provided at the interface of the server by the control system, so that the interface open to the network is placed not only on the server but also on the various sites.

### BRIEF SUMMARY OF THE INVENTION

In the present invention, general affairs companies, job-placement agencies, temporary-employment agencies, and education-related entities such as a high school, junior college, four-year college, technical-vocational school, or other training institution are all referred to as “hiring businesses.”

The first problem to be solved by the invention is how to evaluate anonymous job seekers who apply to a company using the sites devoted to positions/help wanted information. For example, does the person really exist? Is information such as personal data, résumés, and curriculum vitae correct?

The second problem to be solved by the invention is how to evaluate anonymous job seekers when hiring businesses browse information about job seekers and nominate applicants. For example, does person really exist? Is information such as personal data, résumés, and curriculum vitae correct?

The third problem to be solved by the invention is how to evaluate anonymous applicants who request brochures, apply for courses, and inquire about information from education-related entities using the sites devoted to positions/help wanted information. For example, does the anonymous certification candidate really exist? Is information such as personal data, résumés, and curriculum vitae correct?

The fourth problem to be solved by the invention is how to evaluate anonymous certification candidates when the education-related entities browse available information about anonymous certification candidates and select desirable applicants. For example, does the certification candidate really exist? Is information such as personal data, résumés, and curriculum vitae correct?

The fifth problem to be solved by the invention is how to permit job seekers/certification candidates to apply for jobs, request brochures, or apply for courses without worrying about leaks of personal data.

Information about recruiting is provided by setting up the sites devoted to positions/help wanted information on a network such as the Internet, and entering information about recruiting such as information about companies, recruitment, seminars, etc., and maintaining the information in a database. Job seekers enter information related to job seeking, such as résumés, curriculum vitae, and other necessary data for hiring, on the site. The data is maintained in the database, and the information relating to job-seeking is made available on the sites devoted to positions/help wanted information. Job seekers browse through the information and if they find favorable information about recruiting, they may apply anonymously to the hiring business through the application system, using the résumés, curriculum vitae, etc. that they have already entered.

A history of applications, interviews, etc. completed by the job seeker/certification candidate and various notices sent by recruiting companies are automatically tallied and displayed at the sites devoted to positions/help wanted information.

The system is characterized in that the hiring business can browse résumés, curriculum vitae, etc., of anonymous job seekers/certification candidates, make conclusions regarding their skills, and further evaluate the information of anonymous job seekers/certification candidates based on the tallied information.

The system is also characterized in that the hiring business can browse through relevant information regarding anonymous job seekers/certification candidates, make conclusions regarding their skills, further evaluate the information of anonymous job seekers/certification candidates based on tallied information, and make nominations through the system.

Information is provided by setting up sites devoted to positions/help wanted information on the network such as the Internet, and placing a specialized section for recruiting students on the site; education-related entities enter information about companies, courses, mock examinations, etc., and maintain the information in the database so that it may be provided at the specialized section. Job seekers/certification candidates enter information at the site certification candidate such as résumés, curriculum vitae, targeted certifications, targeted courses, and other necessary information for taking courses, and the data is maintained in the database. Job seekers/certification candidates browse information at the specialized section for student recruiting. If they find the desired information, they may anonymously send previously entered résumés, curriculum vitae, etc. to the education-related entity through a system for requesting brochures, applying for courses, and making inquiries.

A history of applications, interviews, etc., completed by the job seeker/certification candidate and various notices sent by recruiting companies are automatically tallied and displayed at the sites devoted to positions/help wanted information.

The system is characterized in that an education-related entity can browse requests for brochures, applications for courses, inquiries, etc., of anonymous certification candidates, make conclusions regarding their skills, and on the server automatically tally information resulting from education-related entities having evaluated the anonymous certification candidates, and based on that tallied information, the education-related entity can make an evaluation of the information that is anonymous.

The system is also characterized in that the education-related entity can browse information of anonymous job seekers/certification candidates, make conclusions regarding their skills, further evaluate the information of anonymous job seekers/certification candidates based on the tallied data, and make nominations through the system.

The system of the present invention allows applicants to apply to companies and have interviews anonymously. Logs of applicants' use of the system and the various notices sent by hiring businesses are automatically tallied and displayed at the sites devoted to positions/help wanted information; a hiring business can then evaluate anonymous job seekers/certification candidates based on the tallied information. Therefore, the system has the following advantages: (1) the credibility of anonymous job-seekers/certification candidates is enhanced; (2) hiring businesses can select and give interviews to anonymous applicants without concerns because applicant credibility is enhanced; (3) job seekers/certification candidates can apply for jobs, request brochures, and apply for courses without worrying about leaks of personal data.

From the following detailed description, in conjunction with the accompanying drawings, the foregoing and other objects, features, aspects, and advantages of the present invention will become readily apparent to those skilled in the art.

### BRIEF DESCRIPTION OF THE SEVERAL VIEWS OF THE DRAWINGS

FIG. 1 is a schematic diagram showing the general system of the invention;

FIG. 2 is an explanatory diagram showing an example of the home page of sites devoted to positions/help wanted information;

FIG. 3 is an explanatory diagram showing an example of My Page for recruiting companies after login on the home page;

FIG. 4 is Flowchart 1 showing a registration process by job seekers/certification candidates at the sites devoted to positions/help wanted information;

FIG. 5 is Flowchart 2 showing a registration process by job seekers/certification candidates at the sites devoted to positions/help wanted information;

FIG. 6 is Flowchart 1 showing a process of registering information regarding recruitment, etc., by the hiring business at the sites devoted to positions/help wanted information;

FIG. 7 is Flowchart 2 showing a process of registering information about recruitment, etc., by the hiring business at the sites devoted to positions/help wanted information;

FIG. 8 is Flowchart 3 showing a process of registering information about recruitment, etc., by the hiring business at the sites devoted to positions/help wanted information;

FIG. 9 is Flowchart 4 showing a process of registering information about recruitment, etc., by the hiring business at the sites devoted to positions/help wanted information;

FIG. 10 is Flowchart 1 showing a process of outputting evaluation data of the hiring business for job seekers/certification candidates;

FIG. 11 is Flowchart 2 showing a process for the hiring business of outputting evaluation data of job seekers/certification candidates;

FIG. 12 is Flowchart 1 showing a process of application of job seekers/certification candidates;

FIG. 13 is Flowchart 2 showing a process of applications by job seekers/certification candidates;

FIG. 14 is a flowchart showing a process of replying to applications and requests for brochures from anonymous job seekers/certification candidates by the hiring business;

FIG. 15 is a flowchart showing a process of replying to the hiring business by job seekers/certification candidates when gaining consent for anonymity from the hiring business;

FIG. 16 is a flowchart showing a process of giving Nth interview to anonymous applicants by the hiring business;

FIG. 17 is a flowchart showing a process of replying to the hiring business by job seekers/certification candidates when getting a notice of Nth interview from the hiring business;

FIG. 18 is a flowchart showing a process of sending a notice of unofficial decision by the hiring business;

FIG. 19 is a flowchart showing a process of replying to the hiring business by job seekers/certification candidates when getting a notice of unofficial decision

FIG. 20 is a flowchart showing a process of sending a notice of appointment by the hiring business;

FIG. 21 is a flowchart showing a process of replying to the hiring business by job seekers/certification candidates when receiving acceptance of appointment from the hiring business;

FIG. 22 is a flowchart showing a process of replying to applications and requests for brochures from job seekers/certification candidates under their real names by the hiring business;

FIG. 23 is a flowchart showing a process of replying to the hiring business by job seekers/certification candidates when receiving acceptance of an interview from the hiring business;

FIG. 24 is a flowchart showing a process of replying to the hiring business by job seekers/certification candidates when receiving acceptance of the Nth interview from the hiring business;

FIG. 25 is a flowchart showing a process of replying to the hiring business by job seekers/certification candidates when receiving an acceptance of unofficial decision from the hiring business;

FIG. 26 is a flowchart showing a process of a notice of appointment by the hiring business;

FIG. 27 is Flowchart 1 showing a process of nominating job seekers/certification candidates by the hiring business;

FIG. 28 is Flowchart 2 showing a process of nominating job seekers/certification candidates by the hiring business;

FIG. 29 is a flowchart showing a process of replying to the hiring business by job seekers/certification candidates when receiving nomination from the hiring business;

FIG. 30 is a flowchart showing a process of giving the Nth interview anonymously by the hiring business;

FIG. 31 is a flowchart showing a process of replying to the hiring business by job seekers/certification candidates when receiving acceptance of the Nth interview from the hiring business;

FIG. 32 is a flowchart showing a process of sending a notice of unofficial decision anonymously by the hiring business;

FIG. 33 is a flowchart showing a process of replying to the hiring business by job seekers/certification candidates when receiving a notice of unofficial decision from the hiring business;

FIG. 34 is a flowchart showing a process of sending a notice of appointment by the hiring business;

FIG. 35 is a flowchart showing a process of replying to the hiring business by job seekers/certification candidates when receiving acceptance of an appointment from the hiring business;

FIG. 36 is a flowchart showing a process of replying to applications and requests for brochures from job seekers/certification candidates under their real name by the hiring business when nominating;

FIG. 37 is a flowchart showing a process of replying to the hiring business by job seekers/certification candidates when receiving a nomination from the hiring business;

FIG. 38 is a flowchart showing a process of giving the Nth interview by the hiring business;

FIG. 39 is a flowchart showing a process of sending a notice of unofficial decision by the hiring business;

FIG. 40 is a flowchart showing a process of sending a notice of appointment by the hiring business; and

FIG. 41 is Table 1, showing an example of “Hiring Businesses' Evaluation Information on Job Seekers/Certification Candidates,” and Table 2, showing an example of “Job Seekers'/Certification Candidates' Evaluation Information on Hiring Businesses.”

### DETAILED DESCRIPTION OF THE INVENTION

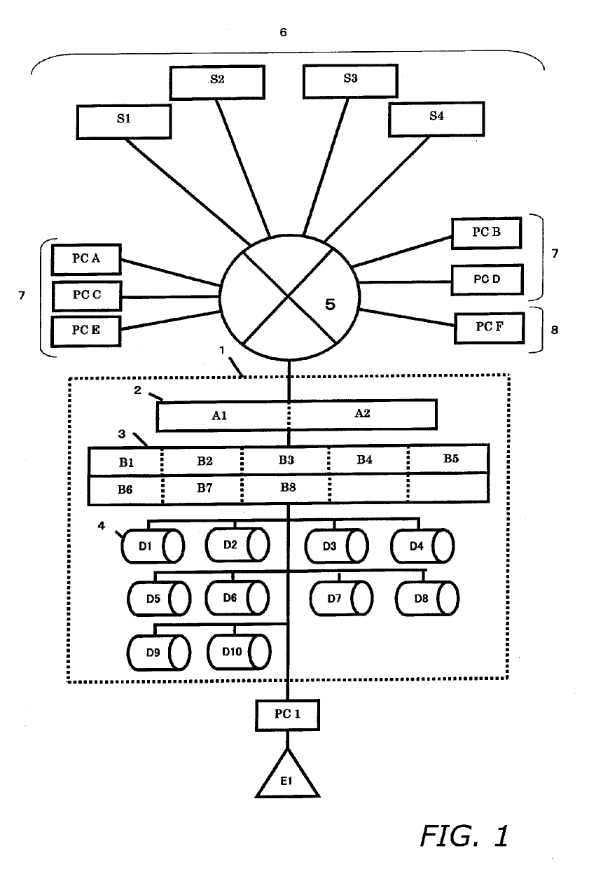

The general system of the invention is shown as FIG. 1.

First, Server 1 for the sites devoted to positions/help wanted information has Interface 2, Control Systems 3, and Databases 4.

Interface 2 comprises interface A1, browsable by personal computer (hereinafter referred to as PC) and interface A2, browsable by mobile terminal, PHS, PDA, etc., and comprising web pages open to network 5 to be browsed.

The web page displays necessary information such as information about job offers and recruiting, job placement, temporary staffing, student recruiting, mock examinations and related information, e-learning information, including web based training, and information about improving careers and skills, etc., and has various register buttons.

These web pages are created as HTML files by known software applications for building homepages such as Homepage Builder (registered trademark of IBM), Golive (registered trademark of Adobe), and any HTML editor. In addition, XSLT (XML Stylesheet Language Transform) files are created by known programs such as Dreamweaver (registered trademark of Macromedia) and style sheet editors. These files are saved in Server 1.

Control Systems 3 include: a control system B1 for functions relating to job seekers/certification candidates; a control system B2 for functions relating to recruiting companies; a control system B3 for providing information about recruitment, courses, seminars, mock examinations, etc., to various sites; a control system B4 for sales; a control system B5 for tallying responses; a control system B6 for users' various logs; a page generator B7 for various sites; a control system B8 for managing evaluations both by job seekers/certification candidates and recruiting companies before and after the interview.

Databases 4 include: a job seekers'/certification candidates database D1 of personal information, and IDs, passwords, and e-mail addresses for the personal information; a job seekers'/certification candidates' database D2 of résumés, curriculum vitae, and desired information, as well as IDs and passwords differing from IDs and passwords in connection with personal information; a recruiting companies' database D3 of IDs, passwords, and e-mail addresses; a database D4 of recruiting company information; a database D5 of information about recruitments and desired information; a database D6 of information about seminars and desired information; a database D7 of users' logs; a database D8 for sales; a D9 database for tallying responses; and a database D10 of evaluations both by job seekers/certification candidates, and recruiting companies before and after interviews.

The above-described system structuring done by a system administrator E1 carrying out configurational operations directly on Server 1 or through Personal Computer PC1 connected to Server 1.

### EMBODIMENT 1

The general system of the present invention is shown as FIG. 1, as mentioned above. First, Server 1 for the sites devoted to positions/help wanted information has Interface 2, Control System 3, and Database 4.

Interface 2 comprises an Interface A1, browsable by PC, and interface A2, browsable by mobile terminal, PHS, PDA, etc., and comprising browsable web pages open to Network 5.

The web pages of Interface 2 have a button for registering a company's information, a button for registering various information, a button for posting at various sites, a button for posting at Server 1, a button for registering IDs, passwords, e-mail addresses of job seekers/certification candidates, and a button for applying and registering résumés and curriculum vitae.

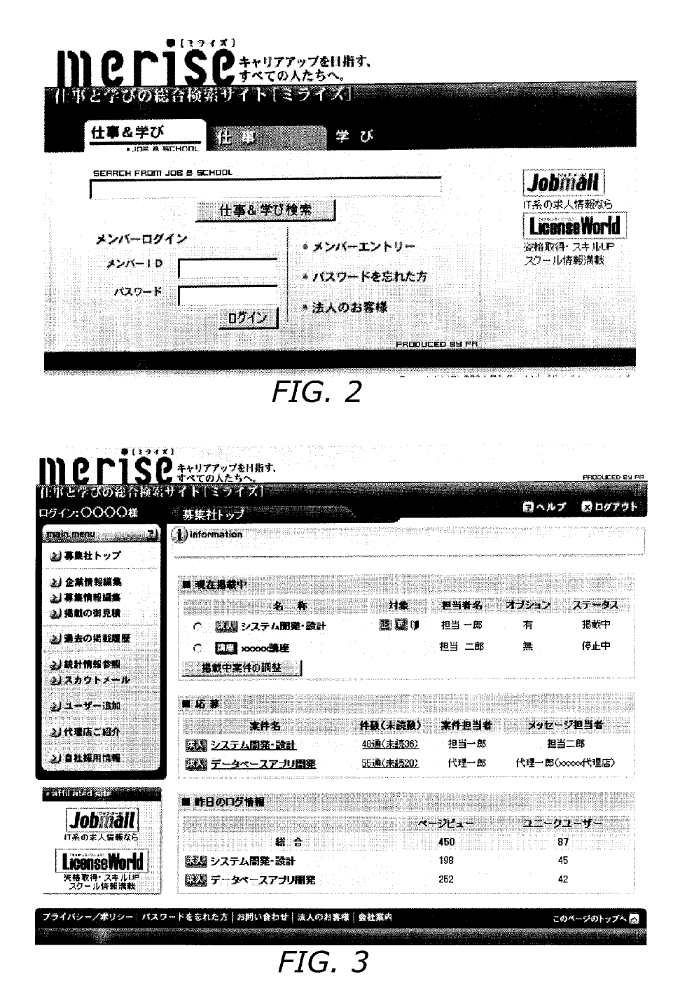

An example of the home page of Interface A1, browsable by PC, is shown as FIG. 2.

Control System 3 accepts registration information about recruitment, courses, seminars, mock examinations, and other information, maintains the information in Database 4 at the same time, keeps the information updated constantly, and provides it to interface 2 as a web page.

A hiring business logs onto Interface A1 via Network 5, and then My Page for the hiring business appears. An example of My Page for a hiring business is shown as FIG. 3.

Next, control system B7 automatically creates a file (File 1) for posting information regarding recruitment, courses, seminars, mock exams, etc., particular to the various sites, saves it to Server 1, and connects to Server 1 to automatically create a file (File 2) in which a program of providing information regarding recruitment, courses, seminars, mock exams, etc., is written.

The first file is linked to various sites, and the second file is saved to the various sites in order to provide information that is also in the various sites.

### EMBODIMENT 2

Next, Embodiment 2 uses the general system of Embodiment 1. The hiring business accesses Interface 2 via Network 5, registers information regarding recruitment, courses, seminars, mock examinations, etc., and other information for posting, and provides the information at Interface 2 of Server 1.

Job-seekers/certification candidates access Interface 2 via Network 5, register résumés and curriculum vitae, and decide whether to provide that information at Interface 2 of Server 1. The option of registering personal data is also provided.

Job-seekers/certification candidates can browse information regarding recruitment, courses, seminars, and mock examinations, and apply for a position or request a brochure of the information anonymously or under their name, and can provide evaluation data of the hiring business providing the information from the viewpoint of a job seeker/certification candidate. The hiring business provides evaluation data from the viewpoint of a hiring business when it receives an application or a request for a brochure from job seeker/certification candidate.

This process enables job-seekers/certification candidates to apply and request brochures not only under their real name but also anonymously without worrying about information leaks at the time of applying or requesting a brochure. Furthermore, the process enables the hiring business to conclude that the anonymous job seeker/certification candidate who applies and requests a brochure really exists and really seeks a job or school.

The process is as follows.

(1) A job seeker/certification candidate accesses Interface A1, browsable by PC, and Interface A2, browsable by mobile terminal, of Interface 2 via Network 5 with PCA-D, enters IDs, passwords, and e-mail addresses in the Login Page, and clicks a button for registering IDs, passwords, and e-mail addresses job seeker/certification candidate Control system B1 operates to save them to database D2.

Next, the Entry Form opens. He/she enters résumés, curriculum vitae, etc., in the form, and clicks the confirmation Button to operate control system B1 and open the Confirmation Page to confirm the data. He/she checks the items entered in Server 1 for displaying on web pages, and clicks a button for saving résumés and curriculum vitae.

Accordingly, the data is saved to database D2, and My Page is registered.

Next, for registering personal data, he/she clicks the Register Button to open the Login Requirement Page, and enters an ID and password which are different from the ones registered at the time of registering the résumés and curriculum vitae as mentioned above.

He/she clicks the Save Button after entering personal data in the form. The data is then saved to database D1.

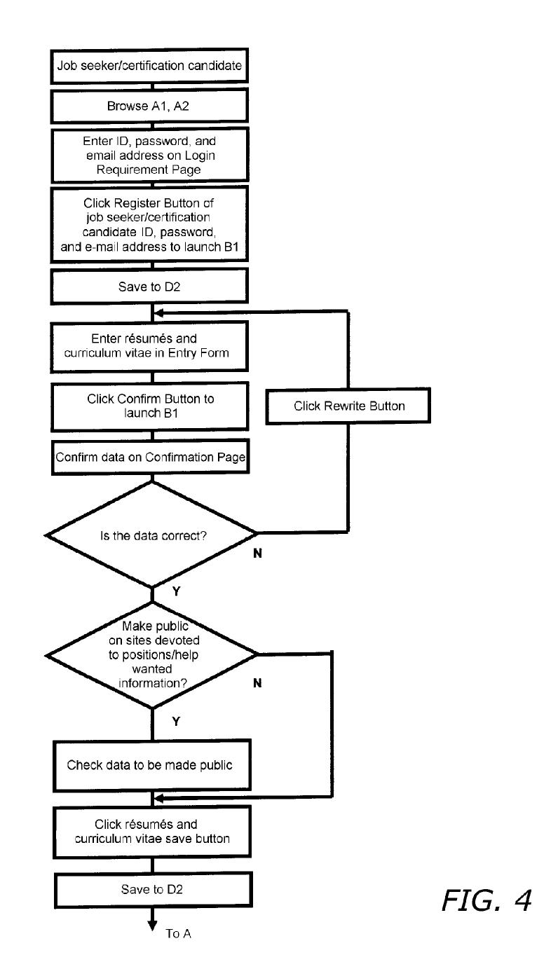

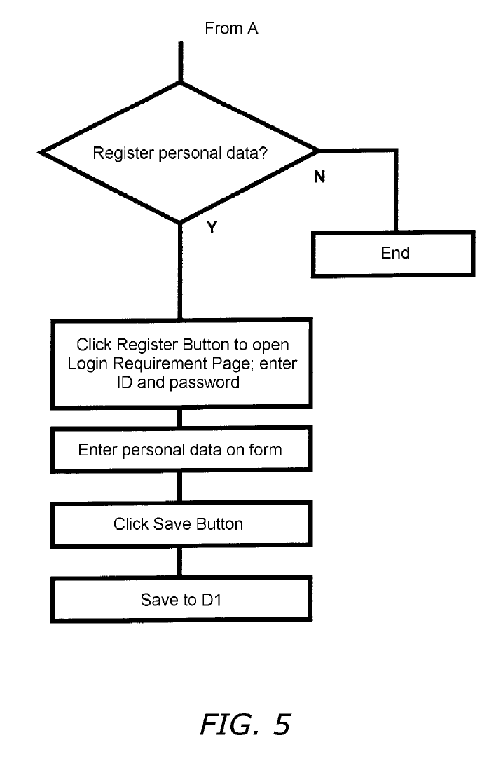

The above procedures for registering résumés, curriculum vitae, and personal data by a job seeker/certification candidate are shown in the flowcharts of FIG. 4 and FIG. 5.

(2) The hiring business accesses Interface A1, browsable by PC, and Interface A2, browsable by mobile terminal, of Interface 2 through Network 5 with PCF, and clicks the For Corporate Client Button. Control system B2 operates, and the Membership Form Page opens. At this page, the hiring business enters the company's and administrator's data, and clicks the Register Button for Company's Information to operate control system B2. The data are then saved to database D3 and database D4, an ID and password are created for each company, and My Page is registered.

The hiring business enters the ID and password already created at Interface A1, browsable by PC, and Interface A2, browsable by mobile terminal, of Interface 2 and clicks the Login Button to open My Page. The hiring business enters information about recruitment, courses, seminars, mock examinations, etc., and clicks the Register Button for various information to operate control system B2 and to save the information to database D5 and to the database of information about seminars and desired information D6.

Next, the hiring business selects information to be posted at Interface A1, browsable by PC, or Interface A2, browsable by mobile terminal, of Interface 2, and clicks the Decide Button. The Frame Purchase Page opens so that the hiring business may select Insertion by Frame Purchase and click Post in Server 1 button to save the information to database D5 and to the database of information about seminars and information desired D6. At the same time, the information is provided at Interface 2.

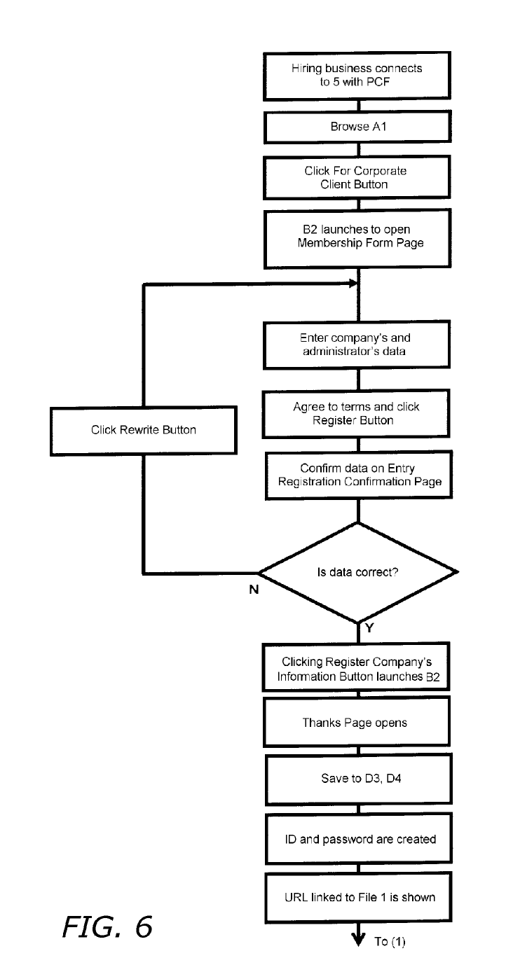

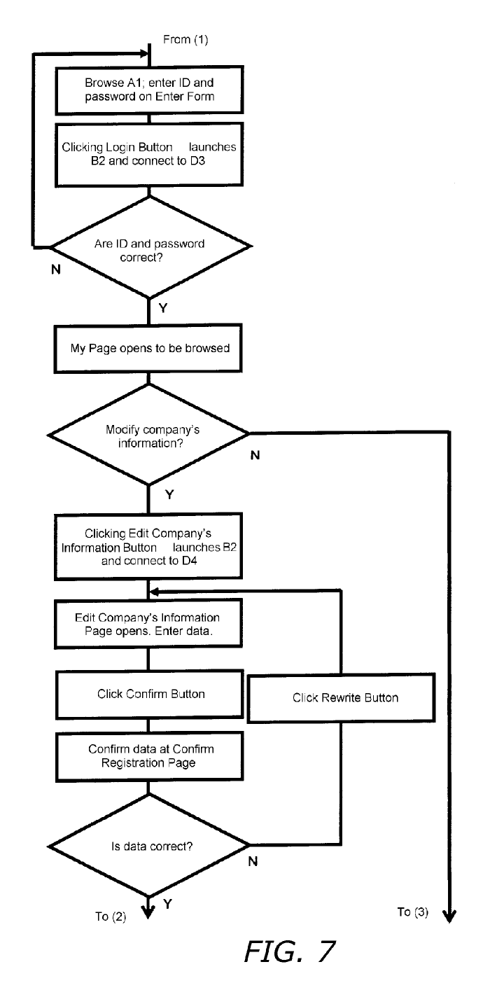

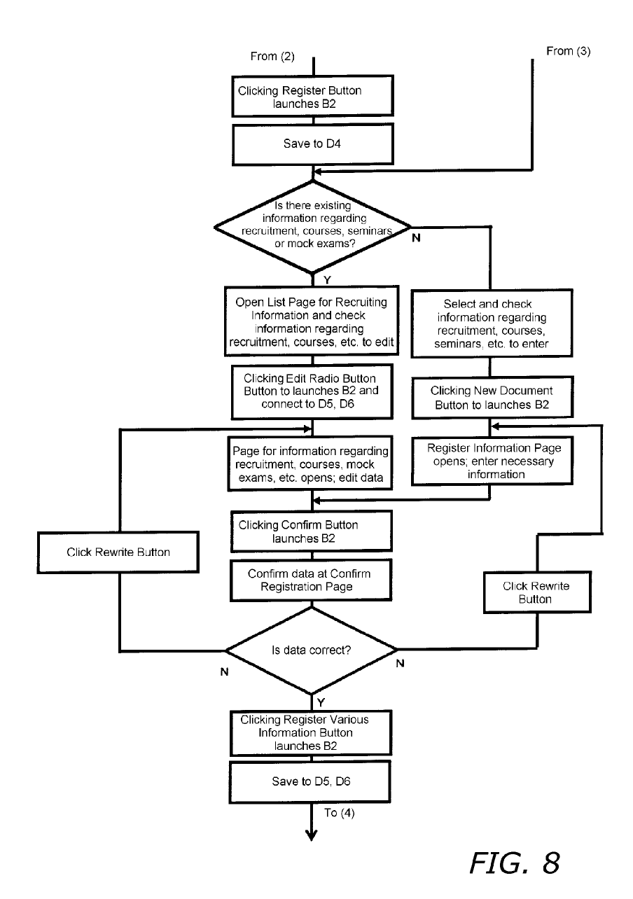

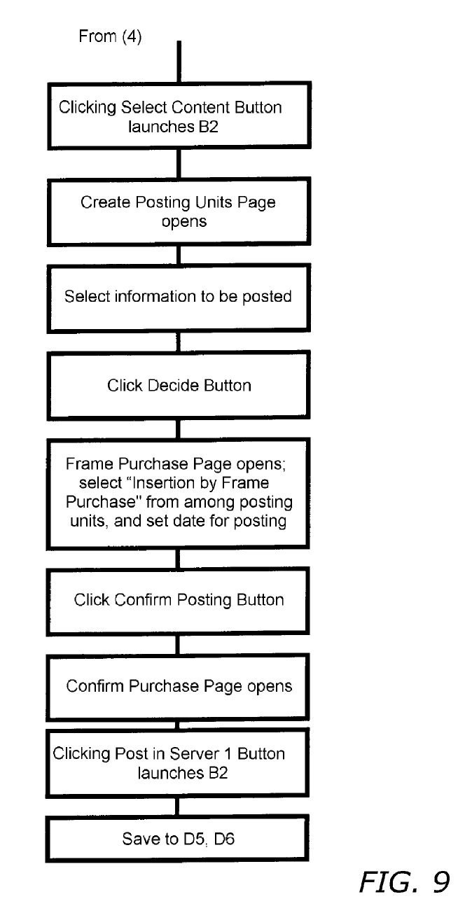

The above procedures for registering information about recruitment, courses, seminars, and mock examinations by the hiring business are shown in the flowcharts of FIG. 6, FIG. 7, FIG. 8, and FIG. 9.

(3) Subsequently, control system B8 operates to connect to database D10.

Next, evaluation points for each sequence and each status are tallied for each hiring business. As a result, Table 1, “Hiring Businesses' Evaluation Information on Job Seekers/Certification Candidates.”

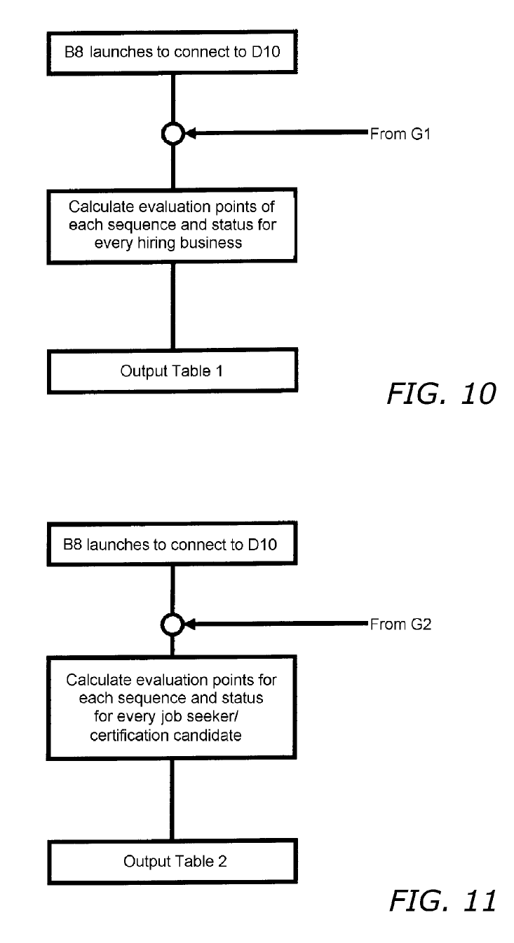

The above procedures for outputting evaluation data of hiring businesses for job seekers/certification candidates are shown in the flowchart of FIG. 10.

(4) Subsequently, control system B8 operates to connect to database D10. Next, evaluation points for each sequence and each status are tallied for each job seeker/certification candidate. As a result, evaluation data of job seekers/certification candidates for a hiring business, Table 2, is outputted.

The above procedures for outputting evaluation data of job seekers/certification candidates for hiring business are shown in the flowchart of FIG. 11.

### EMBODIMENT 3

Next, Embodiment 3 uses the general system of Embodiment 1 and 2. A job seeker/certification candidate accesses Interface A1, browsable by PC, and Interface A2, browsable by mobile terminal, of Interface 2 via Network 5, browses information regarding recruitment, courses, seminars, mock examinations, etc., examines evaluation data of hiring businesses for job seekers/certification candidates, and applies for the position or requests a brochure anonymously or under his/her name.

The hiring business browses the application and the request for a brochure, examines evaluation data of job seekers/certification candidates for hiring businesses, and determines whether to give an interview. After some interviews, hiring is unofficially decided, and the applicant joins the company. The process is shown below.

Furthermore, an anonymous job seeker/certification candidate who applies for the position or requests a brochure can reveal his/her real name at any point in the process mentioned above.

The process is as follows.

(1) A job seeker/certification candidate accesses Interface A1, browsable by PC, or Interface A2, browsable by mobile terminal, of Interface 2 via Network 5 with PCA-D, enters an ID and password in the Enter Form, and clicks the Login Button to open My Page, and then browses information regarding recruitment, courses, seminars, mock examinations, and so on.

After browsing the information, when he/she wants to examine hiring businesses' evaluation information on job seekers/certification candidates, he/she clicks the Yes Button to display Table 1.

Subsequently, in order to apply or request a brochure, he/she clicks a button for applying and registering résumés and curriculum vitae and is connected to the database of résumés, curriculum vitae, and desired information of job seekers/certification candidates D2 to display résumés and curriculum vitae in the Application Page.

After confirming the data and modifying the data if needed, the applicant presses the Confirm Button.

If applying anonymously, the applicant selects “Apply (anonymously),” and clicks the Application Button.

Control system B2 and control system B6 then operate to save résumés and curriculum vitae in database D2 and database D7, while at the same time, control system B8 operates to add and save in database D10 one point to “application event” for the operational sequence and to “applying (anonymously)” for the operational status.

This operation is reflected in Table 1, “Hiring Businesses' Evaluation Information on Job Seekers/Certification Candidates,” and in Table 2, “Job Seekers'/Certification Candidates' Evaluation Information on Hiring Businesses.”

If applying under his/her real name, the applicant selects “Apply (with name),” and clicks the Application Button.

Control system B2 and control system B6 then operate to save résumés and curriculum vitae to database D2 and database D7, while at the same time, control system B8 operates to add and save in database D10 one point to “response event” for the operational sequence and to “apply (with name)” for the operational status.

Next, after entering an ID and password for registering personal data, registered personal data opens, and the applicant confirms the data and clicks the Send Button to operate control system B6 to save the personal data to database D7. This operation is reflected in Tables 1 and 2.

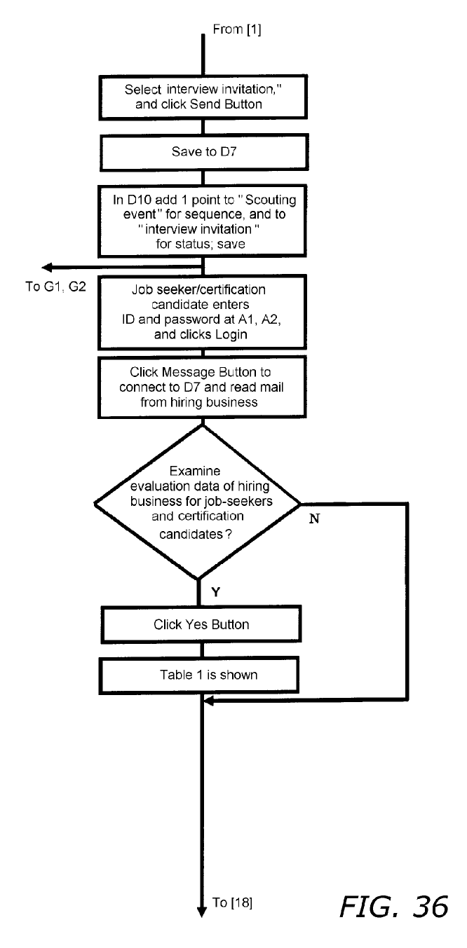

This process flow is tied in with a later-described flow, starting from FIG. 36, for responding with one's real name.

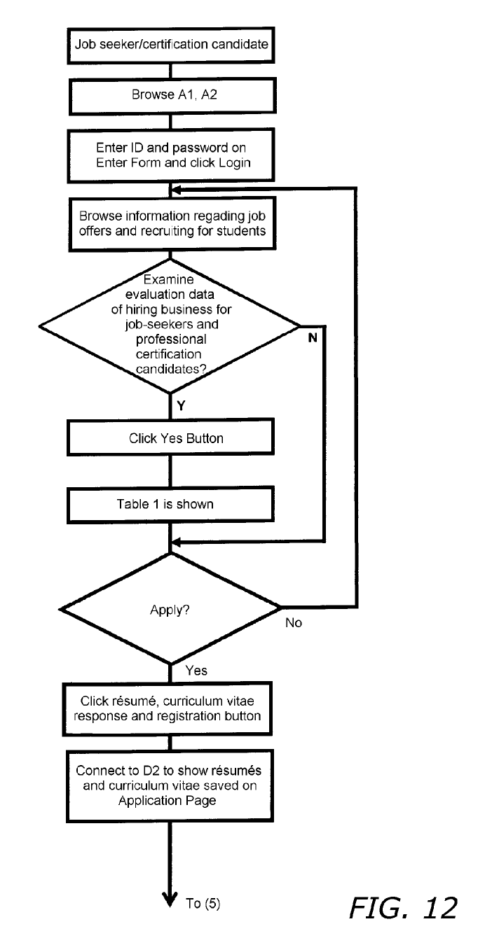

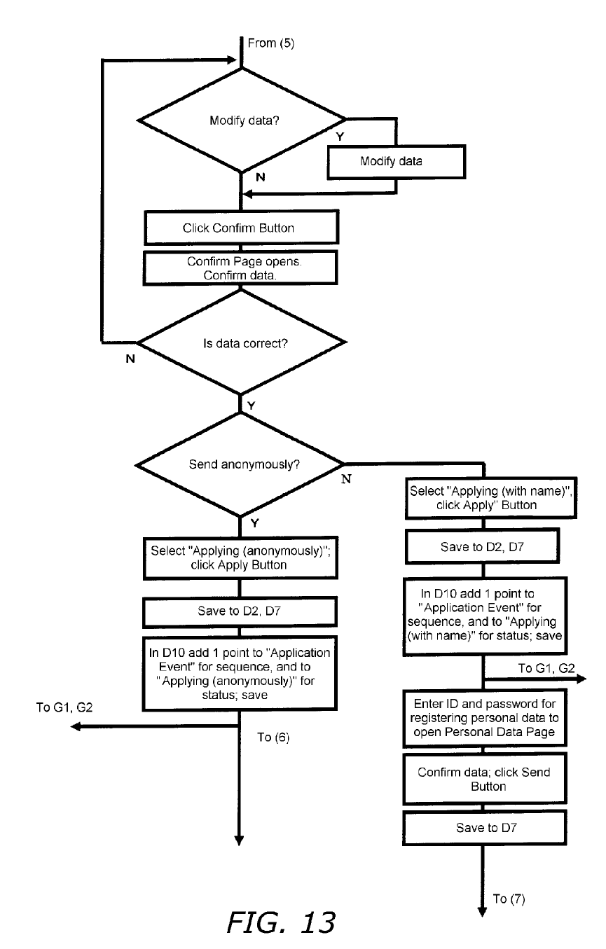

The above procedures or applications by job seekers/certification candidates are shown in the flowcharts of FIG. 12, and FIG. 13.

(2) The hiring business accesses Interface A1 via Network 5 with PCF, enters an ID and password, and clicks the Login Button to open My Page. The business then clicks the Message Button to connect to database D7, and examines applications and requests for brochures.

When the hiring business wants to examine evaluation data of job seekers/certification candidates who have applied or requested brochures, it clicks the Yes Button to output evaluation data of job seekers/certification candidates for hiring businesses, Table 2. As a result, when the hiring business wants to interview the applicant, the procedures will vary depending on the application or request for brochures submitted by the job seeker/certification candidate.

First, in cases in which a job seeker/certification candidate responds anonymously, if the hiring business allows anonymous interviewing, it clicks the Reply Button and selects “Interview Notification (anonymity consented to).”

After clicking Send, control system B6 operates to save the data to database D7, and at the same time, control system B8 operates to add and save in database D10 one point to “application answer event” for the operational sequence and to “interview notification (anonymity accepted)” for the operational status. This operation is reflected in Tables 1 and 2.

In the case of disallowing an anonymous interview, the hiring business clicks the Reply Button and selects “interview notification (name required).” After clicking Send, control system B6 operates to save the data to database D7, and at the same time control system B8 operates to add and save in database D10 one point to “application answer event” for the operational sequence and to “interview notification (name required)” for the operational status. This operation is reflected in Tables 1 and 2.

In the case of rejecting an interview, the hiring business clicks the Reply Button and selects “rejection.” After clicking Send, control system B6 operates to save the data to database D7, and at the same time control system B8 operates to add and save in database D10 one point to “application answer event” for the operational sequence and to “rejection” for the operational status. This operation is reflected in Tables 1 and 2.

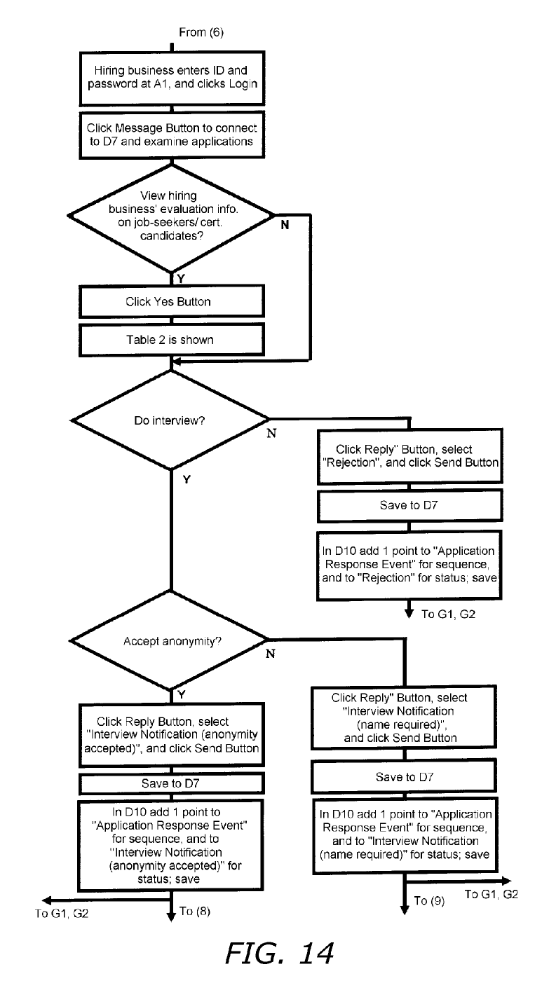

The above procedures for replying to job seekers/certification candidates who have applied anonymously to the hiring businesses are shown in the flowchart of FIG. 14.

(3) A job seeker/certification candidate accesses Interface A1, browsable by PC, or Interface A2, browsable by mobile terminal, of Interface 2 via Network 5 with PCA-D, enters an ID and password in the Enter Form, and clicks the Login Button to open My Page. He/she then clicks the Message Button to connect to database D7 and reads emails sent by the hiring business.

If the job seeker/certification candidate receives a reply of “interview notification (anonymity accepted)” and wants to have an interview, he/she clicks the Reply Button and selects “accept interview (anonymity accepted).”

After clicking Send, control system B6 operates to save the data to database D7, and at the same time control system B8 operates to add and save in database D10 one point to “interview notification answer event” for the operational sequence and to “accept interview (anonymity accepted)” for the operational status. This operation is reflected in Tables 1 and 2.

If the job seeker/certification candidate receives a reply of “interview notification (name required)” and decides to disclose the personal data, he/she clicks the Reply Button and selects “accept interview (name accepted).”

Next, after entering an ID and password for registering personal data, the personal data opens, and the applicant confirms the data and clicks the Send Button to operate control system B6 to save the personal data to database D7; at the same time, control system B8 operates to add and save in database D10 one point to “interview notification answer event” for the operational sequence and to “accept interview (name accepted)” for the operational status. This operation is reflected in Tables 1 and 2.

If the job seeker/certification candidate receives a reply of “interview notification (anonymity accepted)” and does not want to have the interview, or if the job seeker/certification candidate receives a reply of “interview notification (name required)” and does not choose to disclose the personal data, he/she clicks the Reply Button and selects “decline interview.”

After clicking Send, control system B6 operates to save the data to database D7, and at the same time control system B8 operates to add and save in database D10 one point to “interview notification answer event” for the operational sequence and to “decline interview” for the operational status. This operation is reflected in Tables 1 and 2.

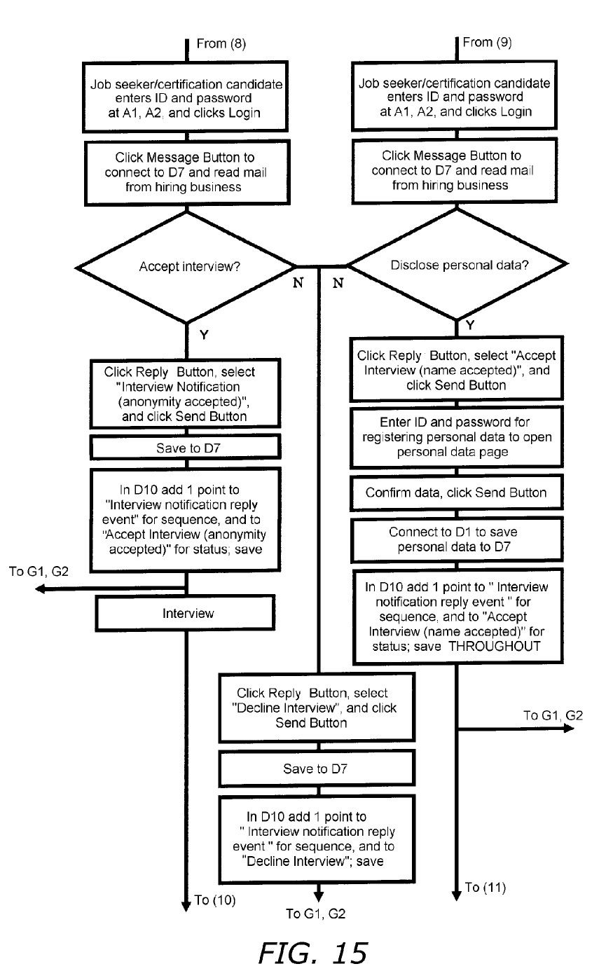

The above procedures for replying to the notice of interview from the hiring businesses by job seekers/certification candidates are shown in the flowchart of FIG. 15.

(4) The hiring business accesses Interface A1 via Network 5 with PCF, enters an ID and password, and clicks the Login Button to open My Page.

In the case of giving the Nth interview and accepting an anonymous interview, the hiring business clicks the Reply Button and selects “notice of Nth interview (anonymity accepted).” After clicking Send, control system B6 operates to save the data to database D7, and at the same time, control system B8 operates to add and save in database D10 one point to “notice of Nth interview” for the operational sequence and to “notice of Nth interview (anonymity accepted)” for the operational status. This operation is reflected in Tables 1 and 2.

In the case of disallowing an anonymous interview, the hiring business clicks the Reply Button and selects “notice of the Nth interview (name required).” After clicking Send, control system B6 operates to save the data to database D7, and at the same time control system B8 operates to add and save in database D10 one point to “notice of Nth interview” for the operational sequence and to “notice of Nth interview (name required)” for the operational status. This operation is reflected in Tables 1 and 2.

On the other hand, in the case of rejecting without the Nth interview, the hiring business clicks the Reply Button and selects “rejection.” After clicking Send, control system B6 operates to save the data to database D7, and at the same time control system B8 operates to add and save in database D10 one point to “notice of Nth interview” for the operational sequence and to “rejection” for the operational status.

In the case of unofficially deciding to hire without the Nth interview, the process goes to the procedures for unofficial decisions. This operation is reflected in Tables 1 and 2.

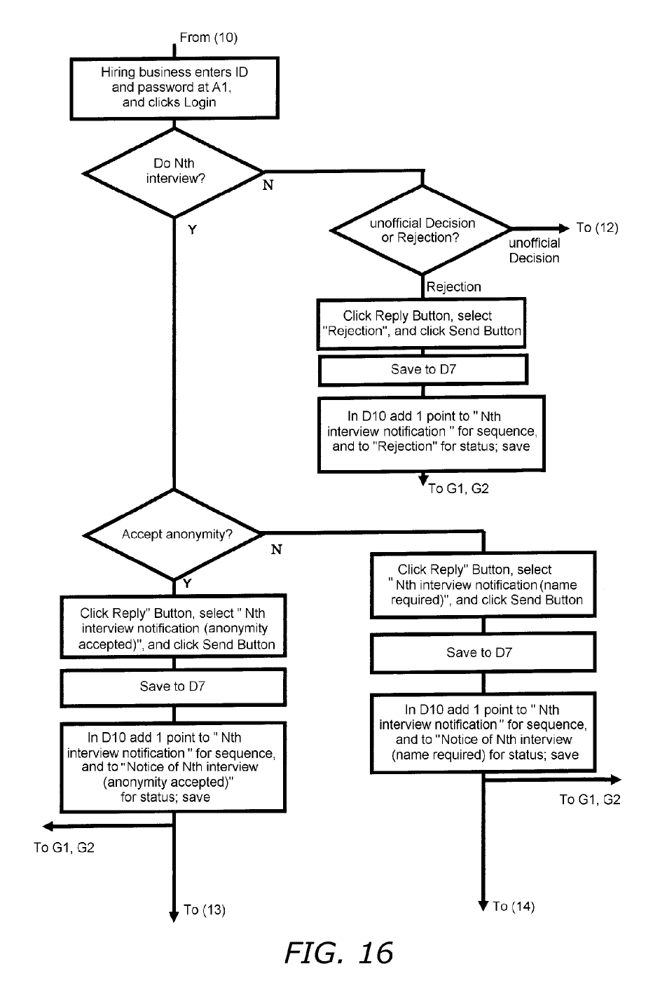

The above procedures for sending notice of the Nth interview to anonymous job seekers/certification candidates by the hiring businesses are shown in the flowchart of FIG. 16.

(5) A job seeker/certification candidate accesses Interface A1, browsable by PC, or Interface A2, browsable by mobile terminal, of Interface 2 via Network 5 with PCA-D, enters an ID and password in the Enter Form, and clicks the Login Button to open My Page. He/she then clicks the Message Button to connect to database D7 and reads emails sent by the hiring businesses.

If the job seeker/certification candidate receives a reply of “notice of the Nth interview (anonymity accepted)” and wants to have an interview, he/she clicks the Reply Button and selects “accept the Nth interview (anonymity accepted).”

After clicking Send, control system B6 operates to save the data to database D7, and at the same time control system B8 operates to add and save in database D10 one point to “Nth interview notification answer event” for the operational sequence and to “accept the Nth interview (anonymity accepted)” for the operational status. This operation is reflected in Tables 1 and 2.

If the job seeker/certification candidate receives a reply of “notice of the Nth interview (name required)” and chooses to disclose the personal data, he/she clicks the Reply Button and selects “accept the Nth interview (name accepted).”

Next, after entering an ID and password for registering personal data, the personal data opens, and the applicant then confirms the data and clicks the Send Button to operate control system B6 to save the personal data to database D7; at the same time control system B8 operates to add and save in database D10 one point to “Nth interview notification answer event” for the operational sequence and to “accept the Nth interview (name accepted)” for the operational status. This operation is reflected in Tables 1 and 2.

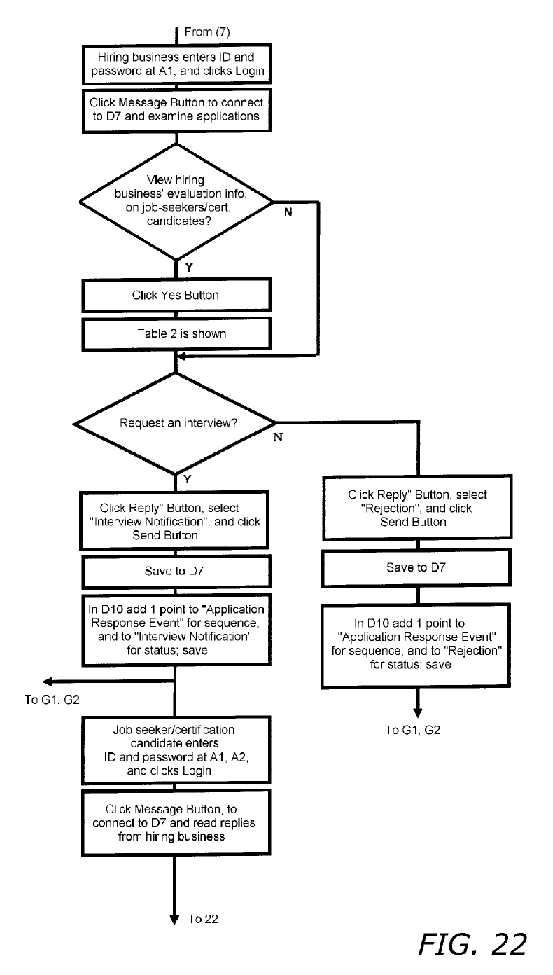

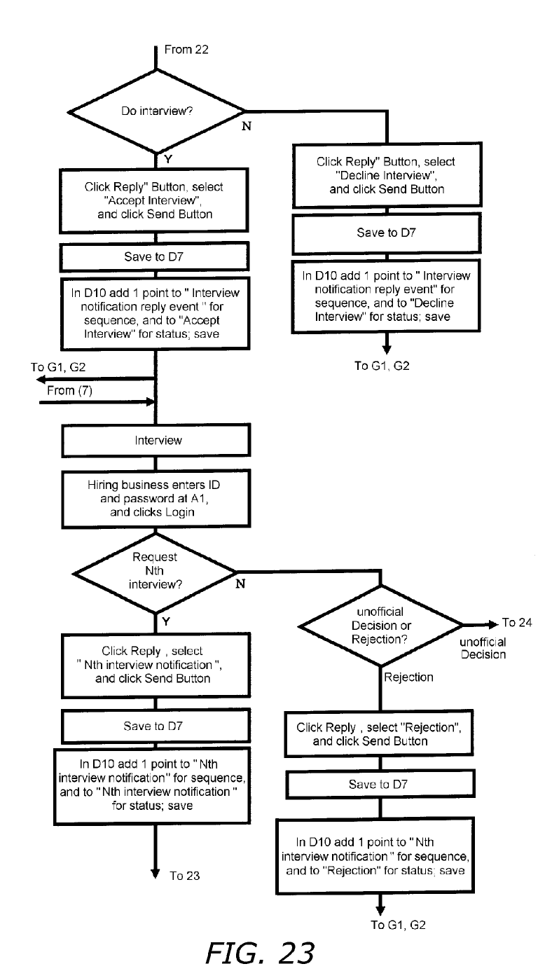

The succeeding process leads to applying with a name, beginning at FIG. 22 as described later.

If job seeker/certification candidate receives a reply of “notice of the Nth interview (anonymity accepted)” and does not want to have the interview, or if the job seeker/certification candidate receives a reply of “notice of the Nth interview (name required)” and does not want to disclose the personal data, he/she clicks the Reply Button and selects “decline the Nth interview.”

After clicking Send, control system B6 operates to save the data to database D7, and at the same time control system B8 operates to add and save in database D10 one point to “Nth interview notification answer event” for the operational sequence and to “decline Nth interview” for the operational status. This operation is reflected in Tables 1 and 2.

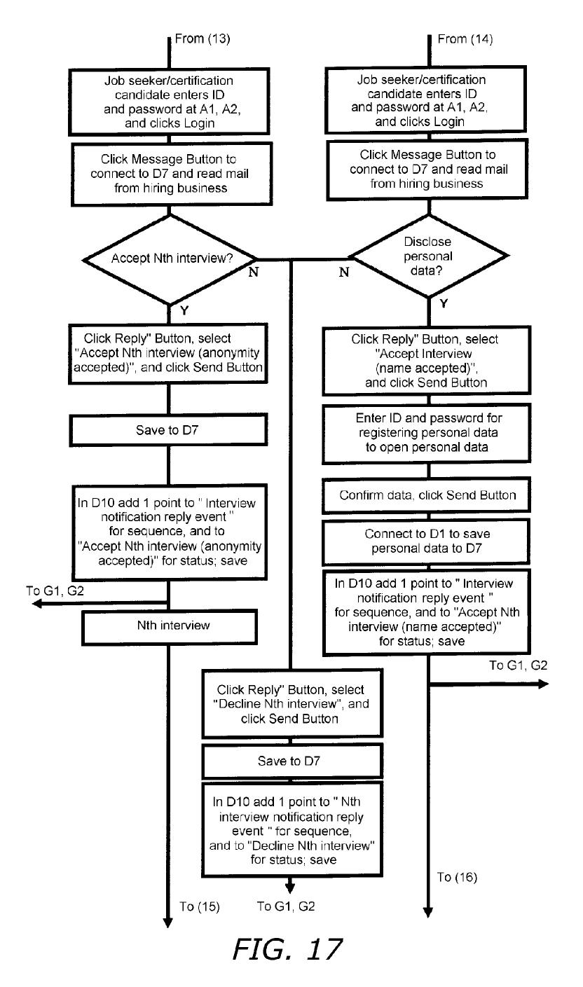

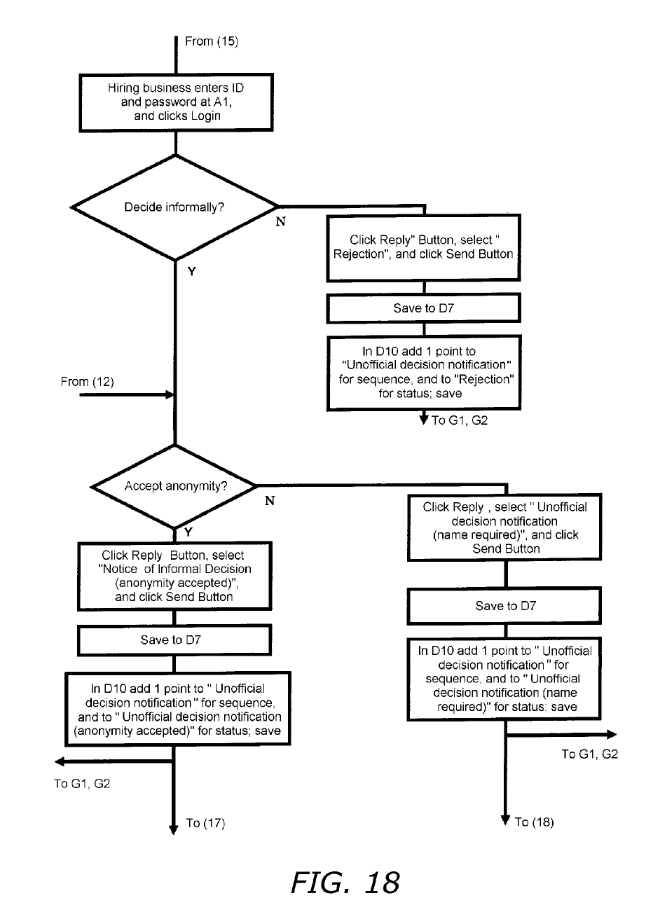

The above procedures for replying to the notice of the Nth interview from the hiring business by job seekers/certification candidates are shown in the flowchart of FIG. 17.

(6) The hiring business accesses Interface A1 via Network 5 with PCF, enters an ID and password, and clicks the Login Button to open My Page.

In cases in which an unofficial decision to hire is made, and in which anonymity is permitted, the hiring business clicks the Reply Button and selects “notice of Unofficial decision (anonymity accepted).” After clicking Send, control system B6 operates to save the data to database D7, and at the same time control system B8 operates to add and save in database D10 one point to “notice of unofficial decision” for the operational sequence and to “notice of unofficial decision (anonymity accepted)” for the operational status. This operation is reflected in Tables 1 and 2.

In the case of disallowing anonymity, the hiring business clicks the Reply Button and selects “interview notification (name required).” After clicking Send, control system B6 operates to save the data to database D7, and at the same time control system B8 operates to add and save in database D10 one point to “notice of unofficial decision” for the operational sequence and to “notice of unofficial decision (name required)” for the operational status. This operation is reflected in Tables 1 and 2.

On the other hand, in the case of disallowing an unofficial decision, the hiring business clicks the Reply Button and selects “rejection.”

After clicking Send, control system B6 operates to save the data to database D7, and at the same time control system B8 operates to add and save in database D10 one point to “notice of unofficial decision” for the operational sequence and to “rejection” for the operational status. This operation is reflected in Tables 1 and 2.

The above procedures for sending notice of unofficial decision by the hiring businesses are shown in the flowchart of FIG. 18.

(7) A job seeker/certification candidate accesses Interface A1, browsable by PC, or Interface A2, browsable by mobile terminal, of Interface 2 via Network 5 with PCA-D, enters an ID and password in the Enter Form, and clicks the Login Button to open My Page. He/she then clicks the Message Button to connect to database D7 and reads emails sent by the hiring business.

If the job seeker/certification candidate receives a reply of “notice of unofficial decision (anonymity accepted),” and wants to join the company, he/she clicks the Reply Button and selects “accept unofficial decision (anonymity accepted).”

After clicking Send, control system B6 operates to save the data to database D7, and at the same time control system B8 operates to add and save in database D10 one point to “unofficial decision notification answer event” for the operational sequence and to “accept unofficial decision (anonymity accepted)” for the operational status. This operation is reflected in Tables 1 and 2.

If job seeker/certification candidate receives a reply of “notice of unofficial decision (name required)” and chooses to disclose the personal data, he/she clicks the Reply Button and selects “accept unofficial decision (name required).”

Next, after entering an ID and password for registering personal data, the personal data opens, and the applicant then confirms the data and clicks the Send Button to operate control system B6 to save the personal data to database D7; at the same time control system B8 operates to add and save in database D10 one point to “unofficial decision notification answer event” for the operational sequence and to “accept unofficial decision (name accepted) notice of interview (anonymity accepted)” for the operational status. This operation is reflected in Tables 1 and 2. The succeeding process leads to applying with a name, beginning at FIG. 22 as described later.

If job seeker/certification candidate receives a reply of “notice of unofficial decision (anonymity accepted)” and does not want to join the company, or if the job seeker/certification candidate receives a reply of “notice of unofficial decision (name required)” and does not choose to disclose the personal data, he/she clicks the Reply Button and selects “decline unofficial decision.”

After clicking Send, control system B6 operates to save the data to database D7, and at the same time control system B8 operates to add and save in database D10 one point to “unofficial decision notification answer event” for the operational sequence and to “decline unofficial decision” for the operational status. This operation is reflected in Tables 1 and 2.

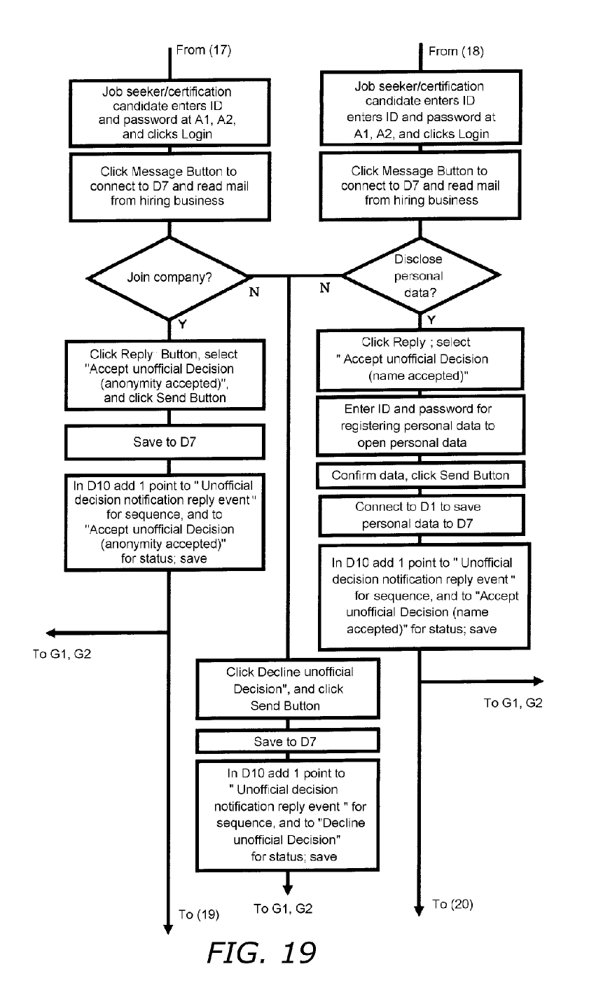

The above procedures of replying to the notice of unofficial decision from the hiring business by job seekers/certification candidates are shown in the flowchart of FIG. 19.

(8) The hiring business accesses Interface A1 via Network 5 with PCF, enters an ID and password, and clicks the Login Button to open My Page.

In the case of receiving “notice of unofficial decision (anonymity accepted),” the hiring business clicks the Reply Button and selects “notice of appointment (name required).” After clicking Send, control system B6 operates to save the data to database D7, and at the same time control system B8 operates to add and save in database D10 one point to “notice of appointment” for the operational sequence and to “notice of Appointment (name required)” for the operational status. This operation is reflected in Tables 1 and 2.

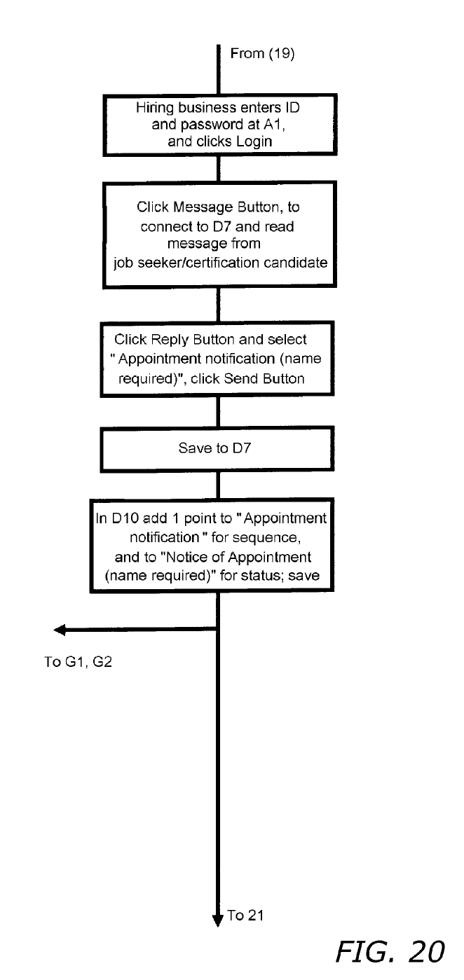

The above procedures of sending notice of Appointment by the hiring business are shown in the flowchart of FIG. 20.

(9) A job seeker/certification candidate accesses Interface A1, browsable by PC, or Interface A2, browsable by mobile terminal, of Interface 2 via Network 5 with PCA-D, enters an ID and password in the Enter Form, and clicks the Login Button to open My Page. He/she then clicks the Message Button to connect to database D7 and reads emails sent by the hiring business.

If job seeker/certification candidate receives a reply of “notice of appointment (name required)” and chooses to disclose the personal data, he/she clicks the Reply Button and selects “accept appointment (name accepted).”

Next, after entering an ID and password for registering personal data, the personal data opens, and the applicant then confirms the data and clicks the Send Button to operate control system B6 to save the personal data to database D7; at the same time, control system B8 operates to add and save in database D10 one point to “appointment notification answer event” for the operational sequence and to “accept notice of appointment (name accepted)” for the operational status. This operation is reflected in Tables 1 and 2. He/she then joins the company.

If job seeker/certification candidate receives a reply of “notice of appointment (name required)” and does not choose to disclose the personal data, he/she clicks the Reply Button and selects “decline appointment.”

After clicking Send, control system B6 operates to save the data to database D7, and at the same time control system B8 operates to add and save in database D10 one point to “appointment notification answer event” for the operational sequence and to “decline appointment” for the operational status. This operation is reflected in Tables 1 and 2.

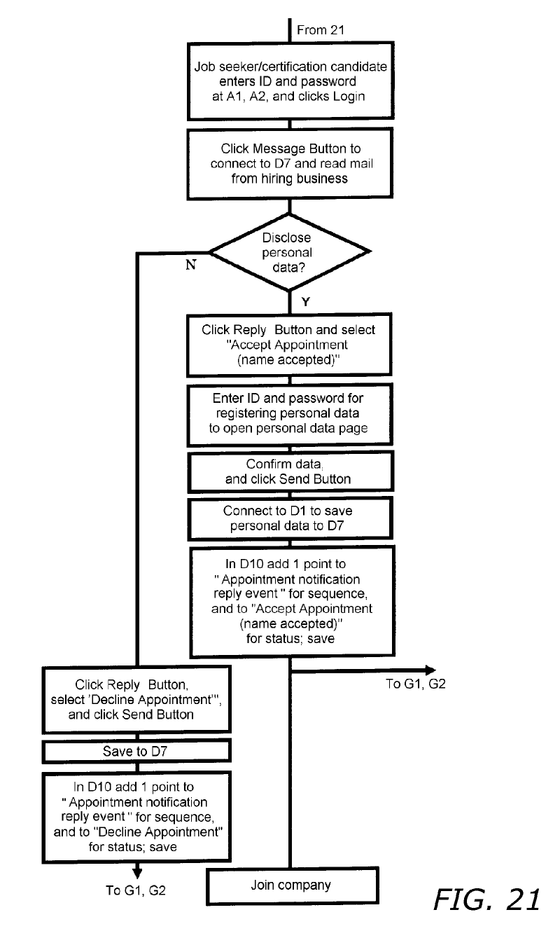

The above procedures for replying to the hiring business by job seekers/certification candidates at the time of receiving acceptance of appointment from the hiring business are shown in the flowchart of FIG. 21.

The process of applying with a real name is as follows.

(10) The hiring business accesses Interface A1 via Network 5 with PCF, and enters an ID and password, and clicks the Login Button to open My Page.

The hiring business then clicks the Message Button to connect to database D7, and examines applications and requests for brochures. When the hiring business wants to examine evaluation data of job seekers/certification candidates who have applied or requested brochures, it clicks the Yes button to output the evaluation data of job seekers/certification candidates for hiring business, Table 2.

When the hiring business decides to give an interview to the applicant, it clicks the Reply Button and selects “interview notification.”

After clicking Send, control system B6 operates to save the data to database D7, and at the same time control system B8 operates to add and save in database D10 one point to “application answer event” for the operational sequence and to “interview notification” for the operational status. This operation is reflected in Tables 1 and 2.

In the case of rejecting an interview, the hiring business clicks the Reply Button and selects “rejection.” After clicking Send, control system B6 operates to save the data to database D7, and at the same time control system B8 operates to add and save in database D10 one point to “application answer event” for the operational sequence and to “rejection” for the operational status. This operation is reflected in Tables 1 and 2.

The above procedures for replying to job seekers/certification candidates who applied under their real names to the hiring business are shown in the flowchart of FIG. 22.

(11) A job-seeker/certification candidate accesses Interface A1, browsable by PC, or Interface A2, browsable by mobile terminal, of Interface 2 via Network 5 with PCA-D, enters an ID and password in the Enter Form, and clicks the Login Button to open My Page.

He/she then clicks the Message Button to connect to database D7 and reads emails sent by the hiring business.

If job seeker/certification candidate receives a reply of “interview notification” and wants to have an interview, he/she clicks the Reply Button and selects “accept interview.”

After clicking Send, control system B6 operates to save the data to database D7, and at the same time control system B8 operates to add and save in database D10 one point to “interview notification answer event” for the operational sequence and to “accept interview” for the operational status. This operation is reflected in Tables 1 and 2.

If job seeker/certification candidate receives a reply of “interview notification” and does not want to have the interview, he/she clicks the Reply Button and selects “decline interview.”

After clicking Send, control system B6 operates to save the data to database D7, and at the same time control system B8 operates to add and save in database D10 one point to “interview notification answer event” for the operational sequence and to “decline interview” for the operational status. This operation is reflected in Tables 1 and 2.

The above procedures of replying to the notice of interview from the hiring business by job seekers/certification candidates are shown in the flowcharts of FIG. 22 and FIG. 23.

(12) The hiring business accesses Interface A1 via Network 5 with PCF, enters an ID and password, and clicks the Login Button to open My Page.

In the case of giving the Nth interview, the hiring business clicks the Reply Button and selects “notice of Nth interview.”

After clicking Send, control system B6 operates to save the data to database D7, and at the same time control system B8 operates to add and save in database D10 one point to “notice of Nth interview” for the operational sequence and to “notice of Nth interview” for the operational status. This operation is reflected in Tables 1 and 2.

On the other hand, in the case of rejecting without the Nth interview, the hiring business clicks the Reply Button and selects “rejection.”

After clicking Send, control system B6 operates to save the data to database D7, and at the same time control system B8 operates to add and save in database D10 one point to “notice of Nth interview” for the operational sequence and to “rejection” for the operational status.

In the case of unofficially deciding to hire without the Nth interview, the process goes to the procedures for unofficial decisions. This operation is reflected in Tables 1 and 2.

The above procedures of giving the Nth interview to the applicants under their real names are shown in the flowchart of FIG. 23.

(13) A job seeker/certification candidate accesses Interface A1, browsable by PC, or Interface A2, browsable by mobile terminal, of Interface 2 via Network 5 with PCA-D, enters an ID and password in the Enter Form, and clicks the Login Button to open My Page. He/she then clicks the Message Button to connect to database D7 and reads emails sent by the hiring business.

If the job seeker/certification candidate receives a reply of “notice of the Nth interview” and wants to have an interview, he/she clicks the Reply Button and selects “accept the Nth interview.”

After clicking Send, control system B6 operates to save the data to database D7, and at the same time control system B8 operates to add and save in database D10 one point to “Nth interview notification answer event” for the operational sequence and to “accept Nth interview” for the operational status. This operation is reflected in Tables 1 and 2.

If job seeker/certification candidate receives a reply of “notice of the Nth interview” and does not want to have the interview, he/she clicks the Reply Button and selects “decline the Nth interview.”

After clicking Send, control system B6 operates to save the data to database D7, and at the same time control system B8 operates to add and save in database D10 one point to “Nth interview notification answer event” for the operational sequence and to “decline Nth interview” for the operational status. This operation is reflected in Tables 1 and 2.

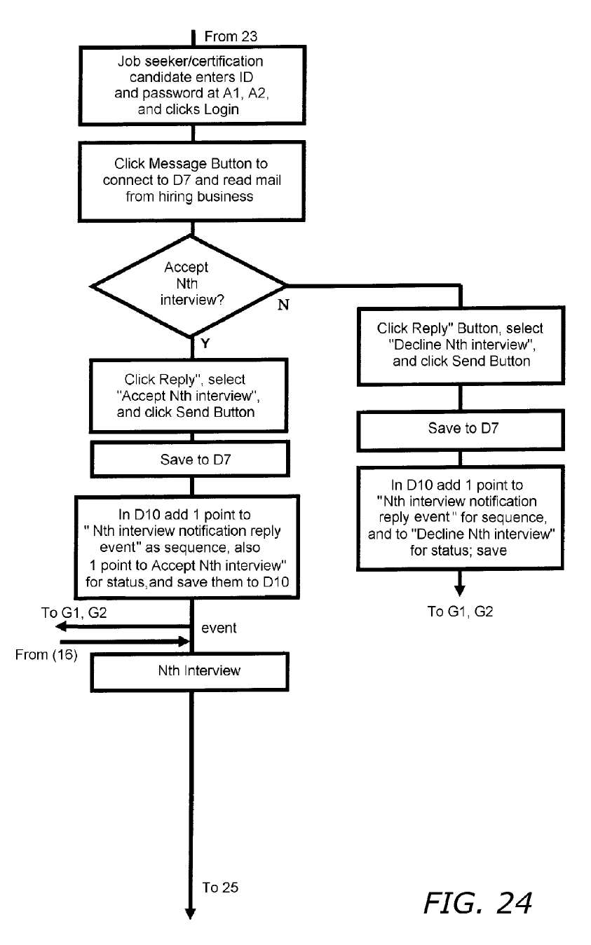

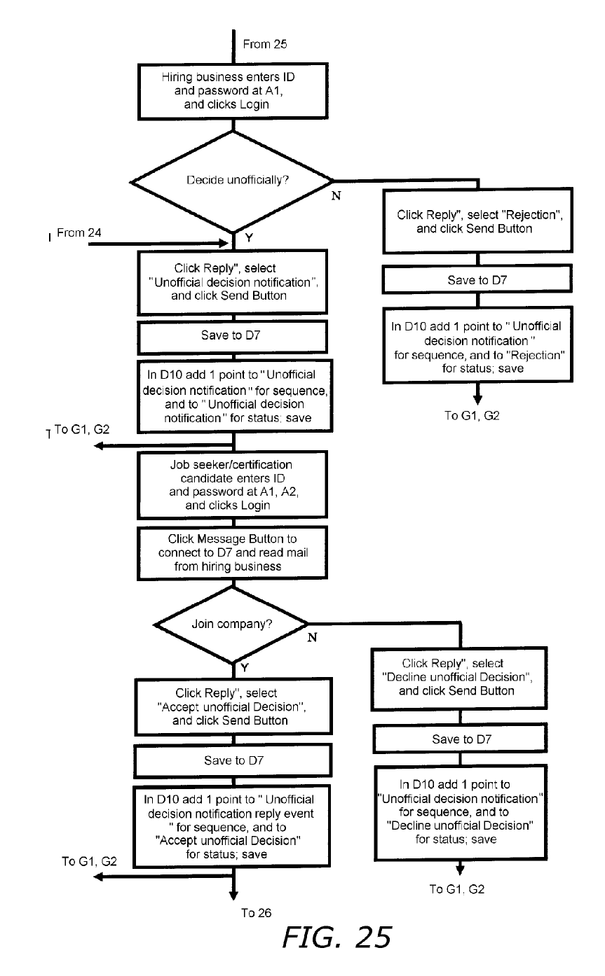

The above procedures of replying to the notice of the Nth interview from the hiring business by job seekers/certification candidates are shown in the flowchart of FIG. 24.

(14) The hiring business accesses Interface A1 via Network 5 with PCF, enters an ID and password, and clicks the Login Button to open My Page.

In the case of unofficially deciding to hire, the hiring business clicks the Reply Button and selects “notice of unofficial decision.”

After clicking Send, control system B6 operates to save the data to database D7, and at the same time control system B8 operates to add and save in database D10 one point to “notice of unofficial decision” for the operational sequence and to “notice of unofficial decision” for the operational status. This operation is reflected in Tables 1 and 2.

In the case of disallowing an unofficial decision, the hiring business clicks the Reply Button and selects “rejection.”

After clicking Send, control system B6 operates to save the data to database D7, and at the same time control system B8 operates to add and save in database D10 one point to “notice of unofficial decision” for the operational sequence and to “rejection” for the operational status. This operation is reflected in Tables 1 and 2.

The above procedures for sending a notice of unofficial decision to the job seeker/certification candidate under his/her real name by the hiring business are shown in the flowchart of FIG. 25.

(15) A job seeker/certification candidate accesses Interface A1, browsable by PC, or Interface A2, browsable by mobile terminal, of Interface 2 via Network 5 with PCA-D, enters an ID and password in the Enter Form, and clicks the Login Button to open My Page.

He/she then clicks the Message Button to connect to database D7 and reads emails sent by the hiring business.

If job seeker/certification candidate receives a reply of “notice of unofficial decision,” and wants to join the company, he/she clicks the Reply Button and selects “accept unofficial decision.”

After clicking Send, control system B6 operates to save the data to database D7, and at the same time control system B8 operates to add and save in database D10 one point to “notice of unofficial decision” for the operational sequence and to “accept unofficial decision” for the operational status. This operation is reflected in Tables 1 and 2.

If job seeker/certification candidate receives a reply of “notice of unofficial decision” and does not want to join the company, or if the job seeker/certification candidate receives a reply of “notice of unofficial decision” and does not choose to disclose the personal data, he/she clicks the Reply Button and selects “decline unofficial decision.”

After clicking Send, control system B6 operates to save the data to database D7, and at the same time control system B8 operates to add and save in database D10 one point to “unofficial decision notification answer event” for the operational sequence and to “decline unofficial decision” for the operational status. This operation is reflected in Tables 1 and 2.

The above procedures of replying to the notice of unofficial decision from the hiring business by job seekers/certification candidates are shown in the flowchart of FIG. 25.

(16) The hiring business accesses Interface A1 via Network 5 with PCF, enters an ID and password, and clicks the Login Button to open My Page.

In the case of receiving “acceptance of unofficial decision,” the hiring business clicks the Reply Button and selects “notice of appointment.”

After clicking Send, control system B6 operates to save the data to database D7, and at the same time control system B8 operates to add and save in database D10 one point to “notice of appointment” for the operational sequence and to “notice of appointment” for the operational status. This operation is reflected in Tables 1 and 2.

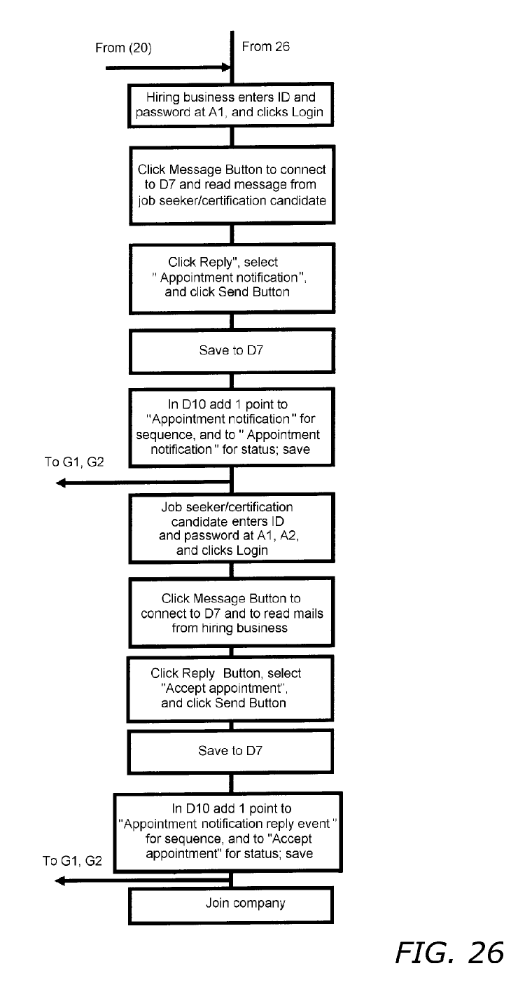

The above procedures of sending notice of appointment to job seekers/certification candidates by the hiring business are shown in the flowchart of FIG. 26.

(17) A job seeker/certification candidate accesses Interface A1, browsable by PC, or Interface A2, browsable by mobile terminal, of Interface 2 via Network 5 with PCA-D, enters an ID and password in the Enter Form, and clicks the Login Button to open My Page. He/she then clicks the Message Button to connect to database D7 and reads emails sent by the hiring business.

If job seeker/certification candidate receives a reply of “notice of appointment,” he/she clicks the Reply Button and selects “accept appointment.

After clicking Send, control system B6 operates to save the data to database D7, and at the same time control system B8 operates to add and save in database D10 one point to “appointment notification answer event” for the operational sequence and to “accept notice of appointment” for the operational status. This operation is reflected in Tables 1 and 2.

The applicant then joins the company.

The above procedures of replying to the hiring business by job seekers/certification candidates at the time of receiving acceptance of appointment from the hiring business are shown in the flowchart of FIG. 26.

These procedures are just examples; the name of each status and sequence and the numbers can be changed and increased or decreased.

### EMBODIMENT 4

Next, Embodiment 4 uses the general system of Embodiment 1, and 2. The hiring business accesses Interface A1 browsable by PC, and Interface A2, browsable by mobile terminal, of Interface 2 via Network 5, and browses information regarding a /job seeker/certification candidate under anonymity or under his/her real name; the hiring business examines evaluation data of job seekers/certification candidates for hiring business, and makes a nomination (scouting email).

A job seeker/certification candidate browses the nomination, and examines evaluation data of hiring businesses for job seekers/certification candidates to decide whether to have an interview. After certain interviews, hiring is unofficially decided, and the applicant joins the company. The process is shown below.

Furthermore, an anonymous job seeker/certification candidate who has not disclosed his/her information can reveal his/her real name at any point in the process mentioned above.

The process is as follows.

(1) The hiring business accesses Interface A1 via Network 5 with PCF, enters an ID and password, and clicks the Login Button to open My Page, and browses information about job seekers/certification candidates.

After browsing the information, and if the hiring business wants to examine evaluation data of job seekers/certification candidates for the hiring business, it clicks the Yes button to output the evaluation data of job seekers/certification candidates for the hiring business, Table 2.

As a result, when the hiring business wants to make a nomination, the procedures will vary depending on the necessity of requiring the name of an anonymous/job seeker/certification candidate.

In the case of job seeker/certification candidate using his/her real name, the succeeding process leads to the procedures beginning at FIG. 36 as described later.

First, in case of allowing the anonymity, the hiring business clicks the Reply Button and selects “invitation to interview (anonymity accepted).”

After clicking Send, control system B6 operates to save the data to database D7, and at the same time control system B8 operates to add and save in database D10 one point to “scouting event” for the operational sequence and to “invitation to interview (anonymity accepted)” for the operational status. This operation is reflected in Tables 1 and 2.

In the case of requiring a name, the hiring business clicks the Reply Button and selects “invitation to interview (name required).” After clicking Send, control system B6 operates to save the data to database D7, and at the same time control system B8 operates to add and save in database D10 one point to “scouting event” for the operational sequence and to “invitation to interview (name required)” for the operational status. This operation is reflected in Tables 1 and 2.

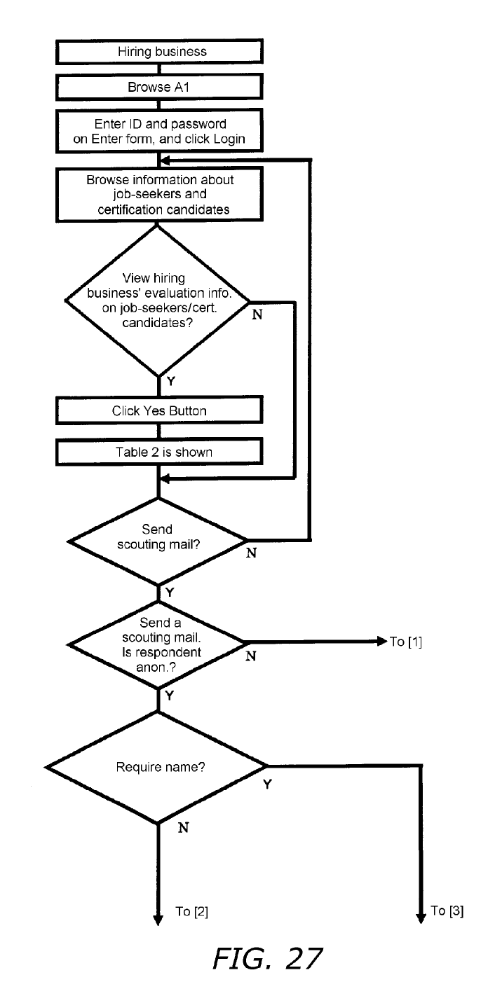

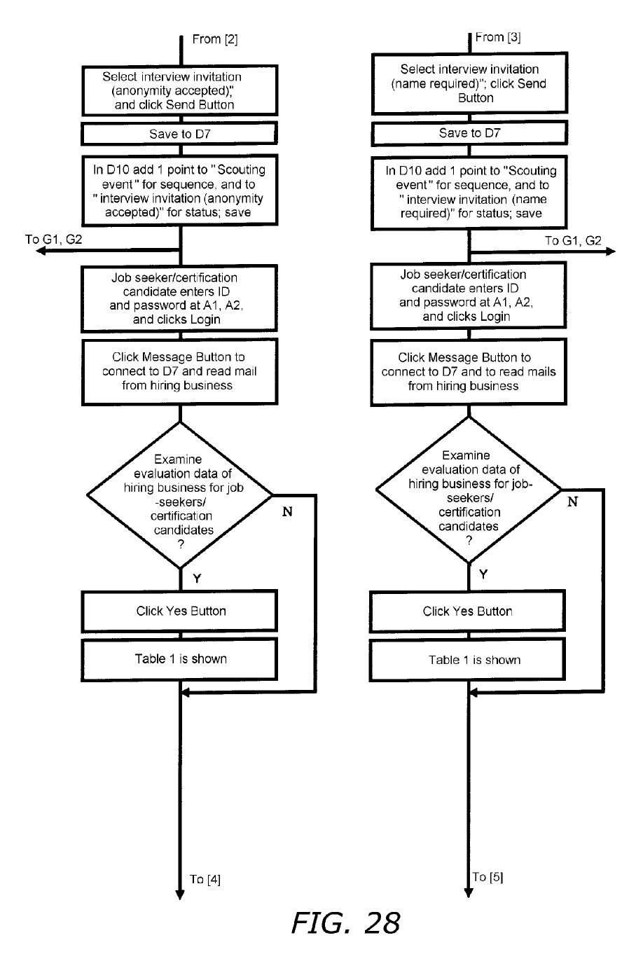

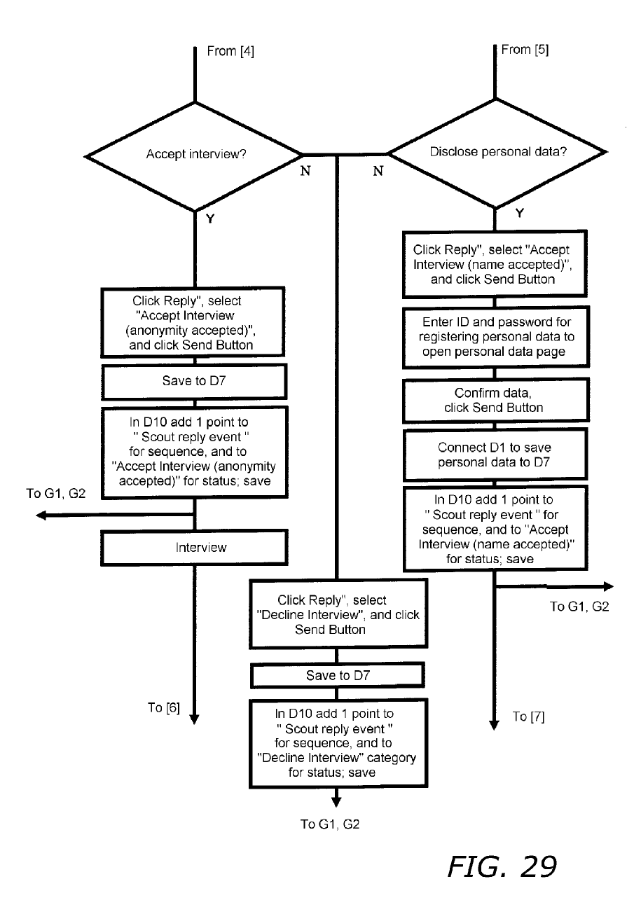

The above procedures of sending a scouting email to nominate a job seeker/certification candidate by the hiring business are shown in the flowcharts of FIG. 27 and FIG. 28.

(2) A job seeker/certification candidate accesses Interface A1 browsable by PC, or Interface A2, browsable by mobile terminal, of Interface 2 via Network 5 with PCA-D, enters an ID and password in the Enter Form, and clicks the Login Button to open My Page.

He/she then clicks the Message Button to connect to database D7 and reads emails sent by the hiring business.

If job seeker/certification candidate receives a reply of “invitation to interview (anonymity accepted)” and examines evaluation data of hiring businesses for job seekers/certification candidates, he/she clicks the Yes Button to output the evaluation data of hiring businesses for job seekers/certification candidates Table 1.

As a result, in case of accepting the interview, the applicant clicks the Reply Button and selects “accept Interview (anonymity accepted).”

After clicking Send, control system B6 operates to save the data to database D7, and at the same time control system B8 operates to add and save in database D10 one point to “scouting answer event” for the operational sequence and to “accept interview (anonymity accepted)” for the operational status. This operation is reflected in Tables 1 and 2.

If job seeker/certification candidate receives a reply of “invitation to interview (name required)”, and decides to examine evaluation data of hiring businesses for job seekers/certification candidates, he/she clicks the Yes Button to output the evaluation data of hiring businesses for job seekers/certification candidates, Table 1.

In the case of disclosing the personal data, the applicant clicks the Reply Button and selects “accept Interview (name accepted).”

Next, after entering an ID and password for registering personal data, the personal data opens; the applicant then confirms the data and clicks the Send Button to operate control system B6 to save the personal data to database D7, and at the same time control system B8 operates to add and save in database D10 one point to “scouting answer event” for the operational sequence and to “accept interview (name accepted)” for the operational status. This operation is reflected in Tables 1 and 2.

The succeeding process leads to nominating the applicant under his/her real name beginning at FIG. 36 as described later.

If job seeker/certification candidate receives a reply of “invitation to interview (anonymity accepted)” and does not want to have the interview, or if the job seeker/certification candidate receives a reply of “invitation to interview (name required)” and does not choose to disclose the personal data, he/she clicks the Reply Button and selects “decline Interview.”

After clicking Send, control system B6 operates to save the data to database D7, and at the same time control system B8 operates to add and save in database D10 one point to “scouting answer event” for the operational sequence and to “decline interview” for the operational status. This operation is reflected in Tables 1 and 2.

The above procedures of replying to the nomination from the hiring business by job seekers/certification candidates are shown in the flowcharts of FIG. 28 and FIG. 29.

(3) The hiring business accesses Interface A1 via Network 5 with PCF, enters an ID and password, and clicks the Login Button to open My Page.

In the case of giving the Nth interview and accepting anonymous interview, the hiring business clicks the Reply Button and selects “notice of Nth Interview (anonymity accepted).”

After clicking Send, control system B6 operates to save the data to database D7, and at the same time control system B8 operates to add and save in database D10 one point to “notice of Nth interview” for the operational sequence and to “notice of Nth interview (anonymity accepted)” for the operational status. This operation is reflected in Tables 1 and 2.

In the case of disallowing an anonymous interview, the hiring business clicks the Reply Button and selects “notice of the Nth Interview (name required).”

After clicking Send, control system B6 operates to save the data to database D7, and at the same time control system B8 operates to add and save in database D10 one point to “notice of Nth interview” for the operational sequence and to “notice of Nth interview (name required)” for the operational status. This operation is reflected in Tables 1 and 2.

On the other hand, in case of rejecting without the Nth interview, the hiring business clicks the Reply Button and selects “rejection.”

After clicking Send, control system B6 operates to save the data to database D7, and at the same time control system B8 operates to add and save in database D10 one point to “notice of Nth interview” for the operational sequence and to “rejection” for the operational status.

In the case of unofficially deciding to hire without the Nth interview, the process goes to the procedures for unofficial decisions. This operation is reflected in Tables 1 and 2.

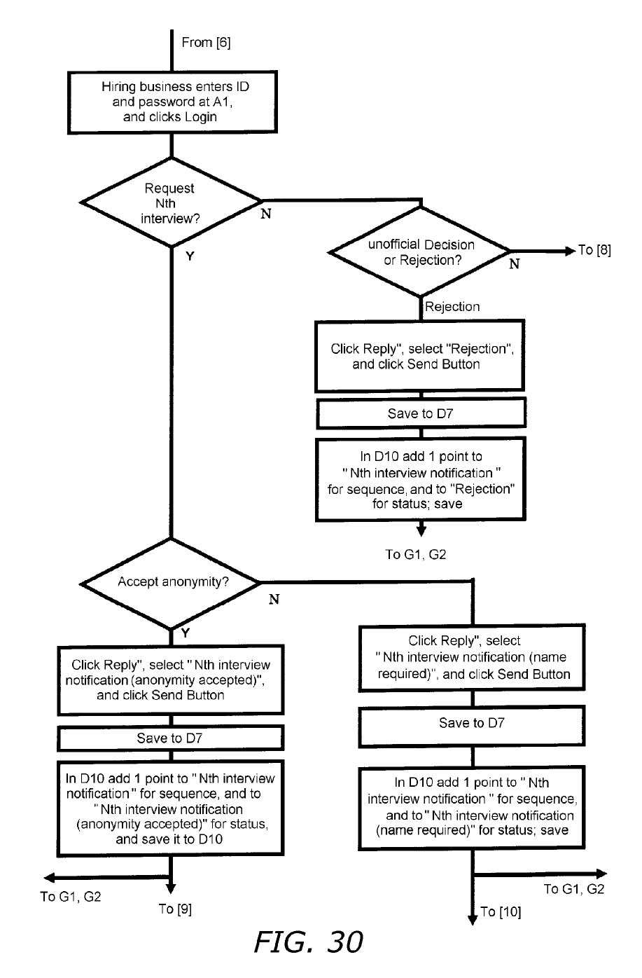

The above procedures of sending notice of the Nth Interview to anonymous job seekers/certification candidates by the hiring business are shown in the flowchart of FIG. 30.

(4) A job seeker/certification candidate accesses Interface A1 browsable by PC, or Interface A2, browsable by mobile terminal, of Interface 2 via Network 5 with PCA-D, enters an ID and password in the Enter Form, and clicks the Login Button to open My Page.

He/she then clicks the Message Button to connect to database D7 and reads emails sent by the hiring business.

If job seeker/certification candidate receives a reply of “notice of the Nth Interview (anonymity accepted)” and wants to have the Nth interview, he/she clicks the Reply Button and selects “accept the Nth interview (anonymity accepted).”

After clicking Send, control system B6 operates to save the data to database D7, and at the same time control system B8 operates to add and save in database D10 one point to “Nth interview notification answer event” for the operational sequence and to “accept the Nth interview (anonymity accepted)” for the operational status. This operation is reflected in Tables 1 and 2.

If a job seeker/certification candidate receives a reply of “notice of the Nth Interview (name required)” and chooses to disclose the personal data, he/she clicks the Reply Button and selects “accept the Nth interview (name accepted).”

Next, after entering an ID and password for registering personal data, the personal data opens; the applicant then confirms the data and clicks the Send Button to operate control system B6 to save the personal data to database D7, and at the same time control system B8 operates to add and save in database D10 one point to “Nth interview notification answer event” for the operational sequence and to “accept the Nth interview (name accepted)” for the operational status. This operation is reflected in Tables 1 and 2. The succeeding process leads to nominating the applicant under his/her real name beginning at FIG. 36 as described later.

If job seeker/certification candidate receives a reply of “notice of the Nth Interview (anonymity accepted)” and does not want to have the interview, or if the job seeker/certification candidate receives a reply of “notice of the Nth Interview (name required)” and does not choose to disclose the personal data, he/she clicks the Reply Button and selects “decline the Nth interview.”

After clicking Send, control system B6 operates to save the data to database D7, and at the same time control system B8 operates to add and save in database D10 one point to “Nth interview notification answer event” for the operational sequence and to “decline Nth interview” for the operational status. This operation is reflected in Tables 1 and 2.

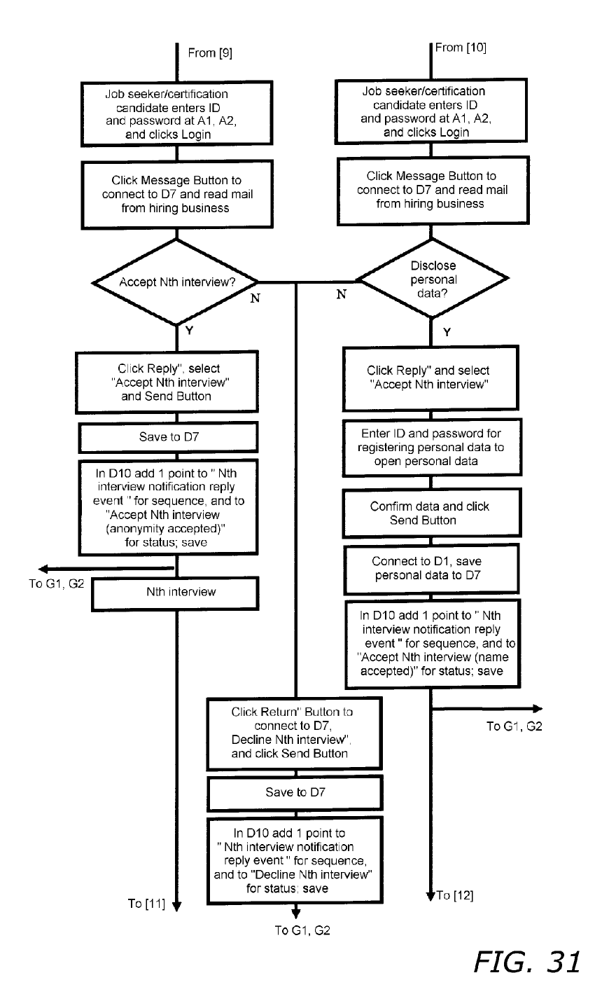

The above procedures of replying to the notice of the Nth Interview from the hiring business by job seekers/certification candidates are shown in the flowchart of FIG. 31.

(5) The hiring business accesses Interface A1 via Network 5 with PCF, enters an ID and password, and clicks the Login Button to open My Page.

In cases in which an unofficial decision to hire is made, and in which anonymity is permitted, the hiring business clicks the Reply Button and selects “notice of unofficial decision (anonymity accepted).”

After clicking Send, control system B6 operates to save the data to database D7, and at the same time control system B8 operates to add and save in database D10 one point to “notice of unofficial decision” for the operational sequence and to “notice of unofficial decision (anonymity accepted)” for the operational status. This operation is reflected in Tables 1 and 2.

In the case of unofficially deciding to hire and disallowing the anonymity, the hiring business clicks the Reply Button and selects “notice of unofficial decision (name required).”

After clicking Send, control system B6 operates to save the data to database D7, and at the same time control system B8 operates to add and save in database D10 one point to “notice of unofficial decision” for the operational sequence and to “notice of unofficial decision (name required)” for the operational status. This operation is reflected in Tables 1 and 2.

On the other hand, in case of disallowing an unofficial decision, the hiring business clicks the Reply Button and selects “rejection.”

After clicking Send, control system B6 operates to save the data to database D7, and at the same time control system B8 operates to add and save in database D10 one point to “notice of unofficial decision” for the operational sequence and to “rejection” for the operational status. This operation is reflected in Tables 1 and 2.

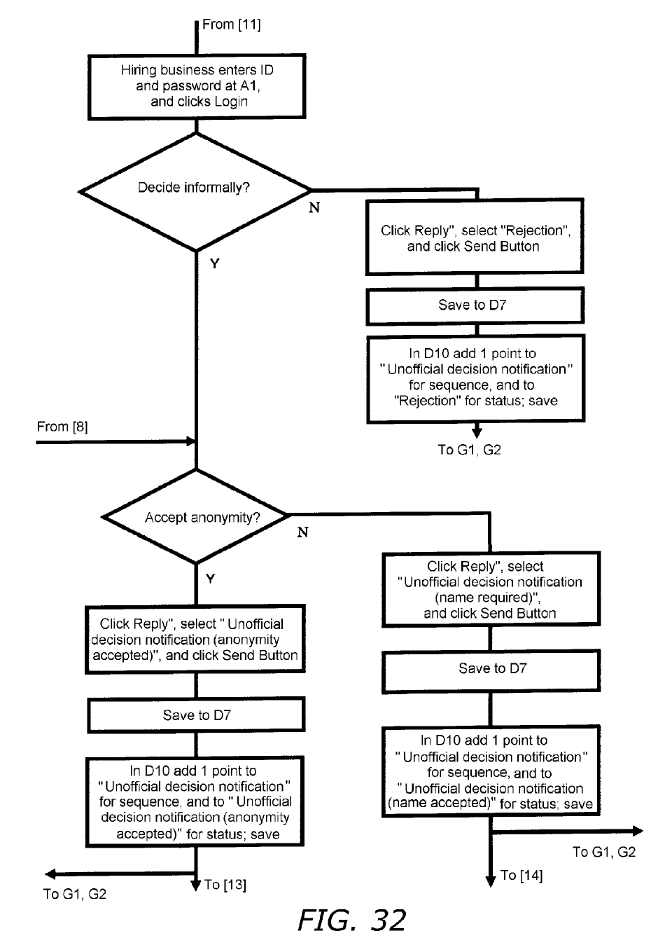

The above procedures of sending notice of unofficial decision to the anonymous job seekers/certification candidates by the hiring business are shown in the flowchart of FIG. 32.

(6) A job seeker/certification candidate accesses Interface A1, browsable by PC, or Interface A2, browsable by mobile terminal, of Interface 2 via Network 5 with PCA-D, enters an ID and password in the Enter Form, and clicks the Login Button to open My Page.

He/she then clicks the Message Button to connect to database D7 and reads emails sent by the hiring business.

If A job seeker/certification candidate receives a reply of “notice of unofficial decision (anonymity accepted),” and wants to join the company, he/she clicks the Reply Button and selects “accept unofficial decision (anonymity accepted).”

After clicking Send, control system B6 operates to save the data to database D7, and at the same time control system B8 operates to add and save in database D10 one point to “unofficial decision notification answer event” for the operational sequence and to “accept unofficial decision” for the operational status. This operation is reflected in Tables 1 and 2.

If A job seeker/certification candidate receives a reply of “notice of unofficial decision (name required)” and chooses to disclose the personal data, he/she clicks the Reply Button and selects “accept unofficial decision (name accepted).”

Next, after entering an ID and password for registering personal data, the personal data opens; the applicant then confirms the data and clicks the Send Button to operate control system B6 to save the personal data to database D7, and at the same time control system B8 operates to add and save in database D10 one point to “unofficial decision notification answer event” for the operational sequence and to “accept unofficial decision (name accepted)” for the operational status. This operation is reflected in Tables 1 and 2.

The succeeding process leads to nominating the applicant under his/her real name beginning at FIG. 36 as described later.

If job seeker/certification candidate receives a reply of “notice of unofficial decision (anonymity accepted)” and does not want to join the company, or if the job seeker/certification candidate receives a reply of “notice of unofficial decision (name required)” and does not choose to disclose the personal data, he/she clicks the Reply Button and selects “decline unofficial decision.”

After clicking Send, control system B6 operates to save the data to database D7, and at the same time control system B8 operates to add and save in database D10 one point to “unofficial decision notification answer event” for the operational sequence and to “decline unofficial decision” for the operational status. This operation is reflected in Tables 1 and 2.

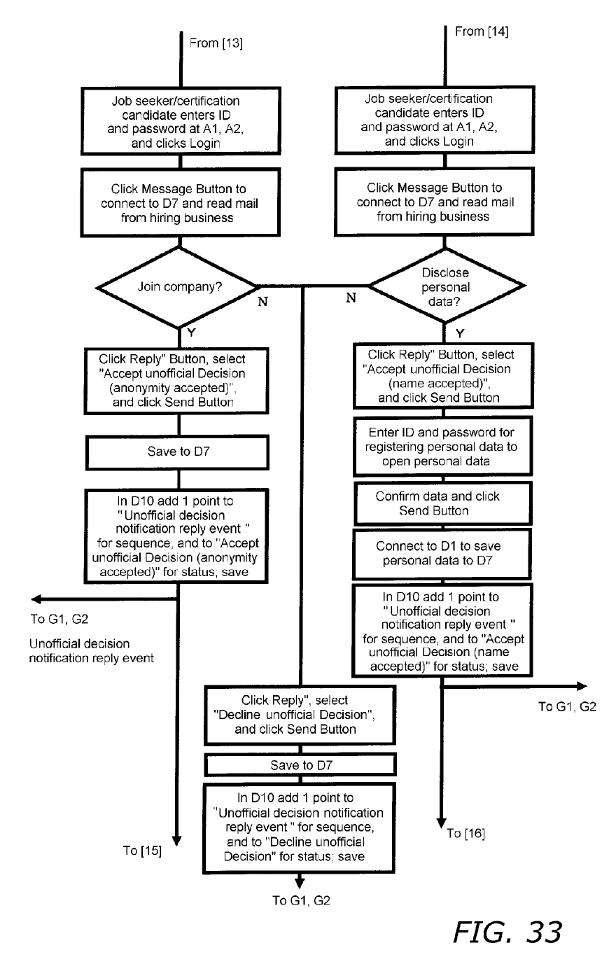

The above procedures of replying to the notice of unofficial decision from the hiring business by job seekers/certification candidates are shown in the flowchart of FIG. 33.

(7) The hiring business accesses Interface A1 via Network 5 with PCF, enters an ID and password, and clicks the Login Button to open My Page.

In the case of receiving “notice of unofficial decision (anonymity accepted),” the hiring business clicks the Reply Button and selects “notice of appointment (name required).”

After clicking Send, control system B6 operates to save the data to database D7, and at the same time control system B8 operates to add and save in database D10 one point to “notice of appointment” for the operational sequence and to “notice of appointment (name required)” for the operational status. This operation is reflected in Tables 1 and 2.

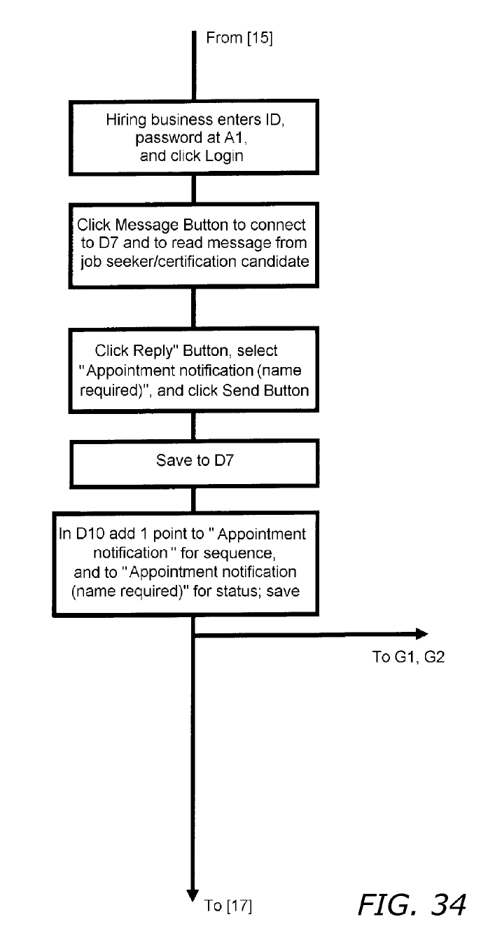

The above procedures of sending notice of appointment by the hiring business are shown in the flowchart of FIG. 34.

(8) A job seeker/certification candidate accesses Interface A1, browsable by PC, or Interface A2, browsable by mobile terminal, of Interface 2 via Network 5 with PCA-D, enters an ID and password in the Enter Form, and clicks the Login Button to open My Page.

He/she then clicks the Message Button to connect to database D7 and reads emails sent by the hiring business.

If a job seeker/certification candidate receives a reply of “notice of appointment (name required)” and chooses to disclose the personal data, he/she clicks the Reply Button and selects “accept appointment (name required).”

Next, after entering an ID and password for registering personal data, the personal data opens; then the applicant confirms the data and clicks the Send Button to operate control system B6 to save the personal data to database D7, and at the same time control system B8 operates to add and save in database D10 one point to “appointment notification answer event” for the operational sequence and to “accept notice of appointment (name accepted)” for the operational status. This operation is reflected in Tables 1 and 2. He/she then joins the company.

If A job seeker/certification candidate receives a reply of “notice of appointment (name required)” and does not choose to disclose the personal data, he/she clicks the Reply Button and selects “decline appointment.”

After clicking Send, control system B6 operates to save the data to database D7, and at the same time control system B8 operates to add and save in database D10 one point to “appointment notification answer event” for the operational sequence and to “decline appointment” for the operational status. This operation is reflected in Tables 1 and 2.

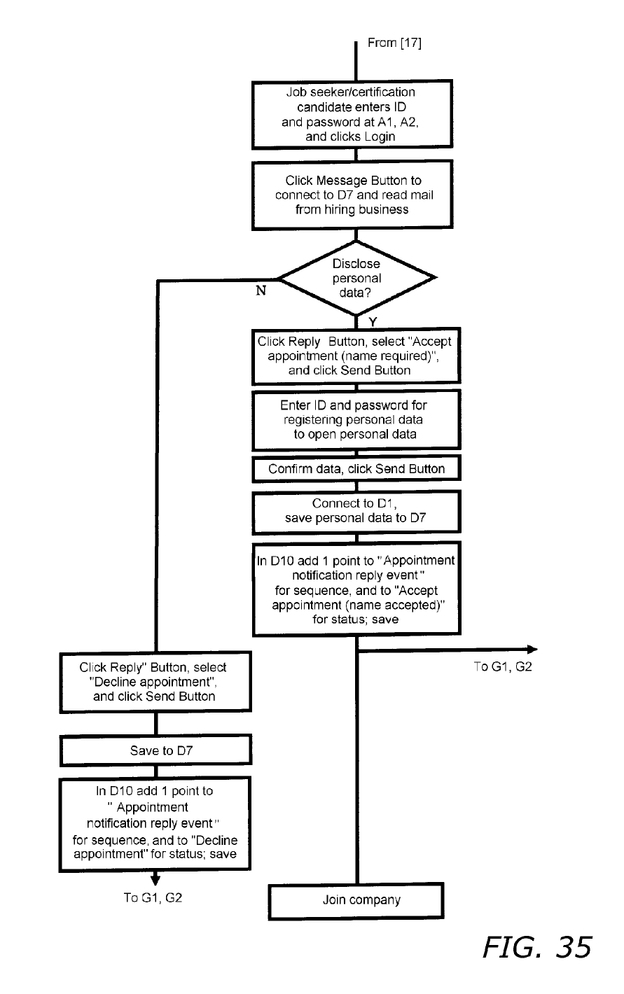

The above procedures of replying to the hiring business by job seekers/certification candidates at the time of receiving acceptance of appointment from the hiring business are shown in the flowchart of FIG. 35.

(9) The process of nominations using real names is as follows.

The hiring business clicks the Reply Button and selects “invitation to interview.”

After clicking Send, control system B6 operates to save the data to database D7, and at the same time control system B8 operates to add and save in database D10 one point to “scouting event” for the operational sequence and to “invitation to interview” for the operational status. This operation is reflected in Tables 1 and 2.

The above procedures for nominating A job seeker/certification candidate under his/her real name by the hiring business are shown in the flowchart of FIG. 36.

(10) A job seeker/certification candidate accesses Interface A1, browsable by PC, or Interface A2, browsable by mobile terminal, of Interface 2 via Network 5 with PCA-D, enters an ID and password in the Enter Form, and clicks the Login Button to open My Page. He/she then clicks the Message Button to connect to database D7 and reads emails sent by the hiring business.

If A job seeker/certification candidate receives a reply of “invitation to interview” and decides to examine evaluation data of hiring businesses for job seekers/certification candidates, he/she clicks the the evaluation Button to output the evaluation data of hiring businesses for job seekers/certification candidates Table 1.

If accepting the interview, the applicant clicks the Yes Button and selects “accept interview.”

After clicking Send, control system B6 operates to save the data to database D7, and at the same time control system B8 operates to add and save in database D10 one point to “scouting answer event” for the operational sequence and to “accept interview” for the operational status. This operation is reflected in Tables 1 and 2.

If a job seeker/certification candidate does not want to have the interview, he/she clicks the Reply Button and selects “decline interview.”

After clicking Send, control system B6 operates to save the data to database D7, and at the same time control system B8 operates to add and save in database D10 one point to “scouting answer event” for the operational sequence and to “decline interview” for the operational status. This operation is reflected in Tables 1 and 2.

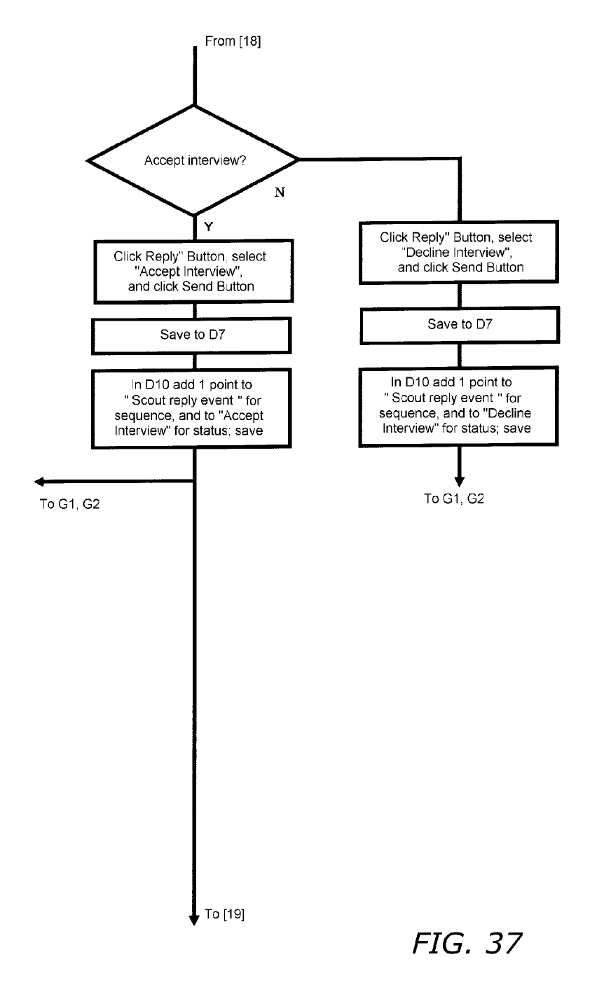

The above procedures of replying to the nomination from the hiring business by job seekers/certification candidates are shown in the flowcharts of FIG. 36 and FIG. 37.

(11) The hiring business accesses Interface A1 via Network 5 with PCF, enters an ID and password, and clicks the Login Button to open My Page.

In the case of giving the Nth interview, the hiring business clicks the Reply Button and selects “notice of Nth Interview.”

After clicking Send, control system B6 operates to save the data to database D7, and at the same time control system B8 operates to add and save in database D10 one point to “notice of Nth interview” for the operational sequence and to “notice of Nth interview” for the operational status. This operation is reflected in Tables 1 and 2.

In the case of rejecting without the Nth interview, the hiring business clicks the Reply Button and selects “rejection.”

After clicking Send, control system B6 operates to save the data to database D7, and at the same time control system B8 operates to add and save in database D10 one point to “notice of Nth interview” for the operational sequence and to “rejection” for the operational status.

In the case of unofficially deciding to hire without the Nth interview, the process goes to the procedures for unofficial decisions. This operation is reflected in Tables 1 and 2.

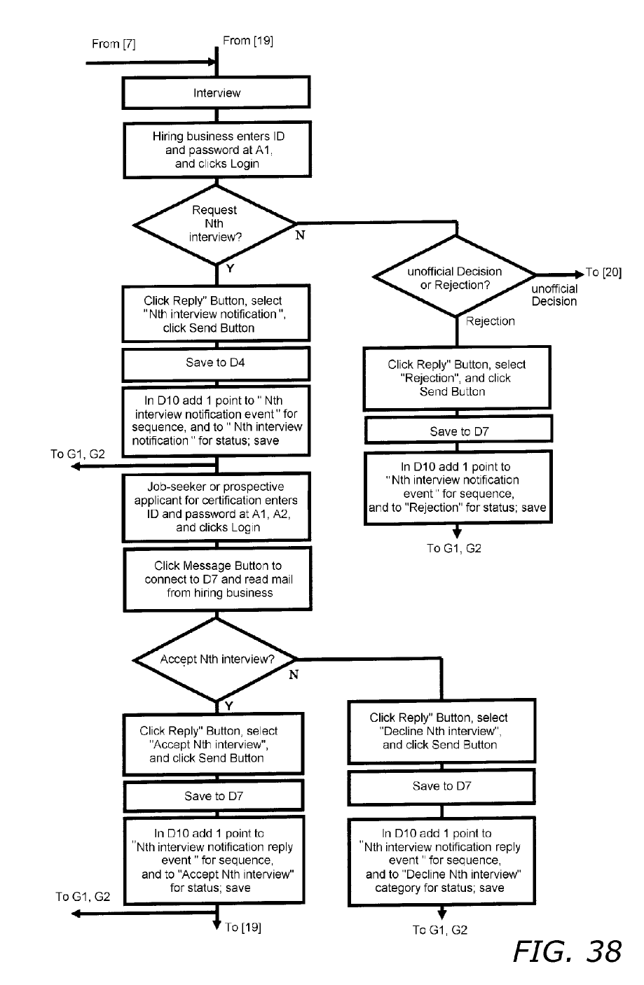

The above procedures of giving the Nth interview by the hiring business are shown in the flowchart of FIG. 38.

(12) A job seeker/certification candidate accesses Interface A1, browsable by PC, or Interface A2, browsable by mobile terminal, of Interface 2 via Network 5 with PCA-D, enters an ID and password in the Enter Form, and clicks the Login Button to open My Page.

He/she then clicks the Message Button to connect to database D7 and reads emails sent by the hiring business.

If a job seeker/certification candidate receives a reply of “notice of the Nth Interview” and wants to have the Nth interview, he/she clicks the Reply Button and selects “accept the Nth interview.”

After clicking Send, control system B6 operates to save the data to database D7, and at the same time control system B8 operates to add and save in database D10 one point to “Nth interview notification answer event” for the operational sequence and to “accept the Nth interview” for the operational status. This operation is reflected in Tables 1 and 2.

If a job seeker/certification candidate does not want to have the interview, he/she clicks the Reply Button and selects “decline the Nth interview.”

After clicking Send, control system B6 operates to save the data to database D7, and at the same time control system B8 operates to add and save in database D10 one point to “Nth interview notification answer event” for the operational sequence and to “decline the Nth interview” for the operational status. This operation is reflected in Tables 1 and 2.

The above procedures of replying to the notice of the Nth Interview from the hiring business by job seekers/certification candidates are shown in the flowchart of FIG. 38.

(13) The hiring business accesses Interface A1 via Network 5 with PCF, enters an ID and password, and clicks the Login Button to open My Page.

In the case of unofficially deciding to hire, the hiring business clicks the Reply Button and selects “notice of unofficial decision.”

After clicking Send, control system B6 operates to save the data to database D7, and at the same time control system B8 operates to add and save in database D10 one point to “notice of unofficial decision” for the operational sequence and to “unofficial notification” for the operational status. This operation is reflected in Tables 1 and 2.

In the case of disallowing an unofficial decision, the hiring business clicks the Reply Button and selects “rejection.”

After clicking Send, control system B6 operates to save the data to database D7, and at the same time control system B8 operates to add and save in database D10 one point to “notice of unofficial decision” for the operational sequence and to “rejection” for the operational status. This operation is reflected in Tables 1 and 2.

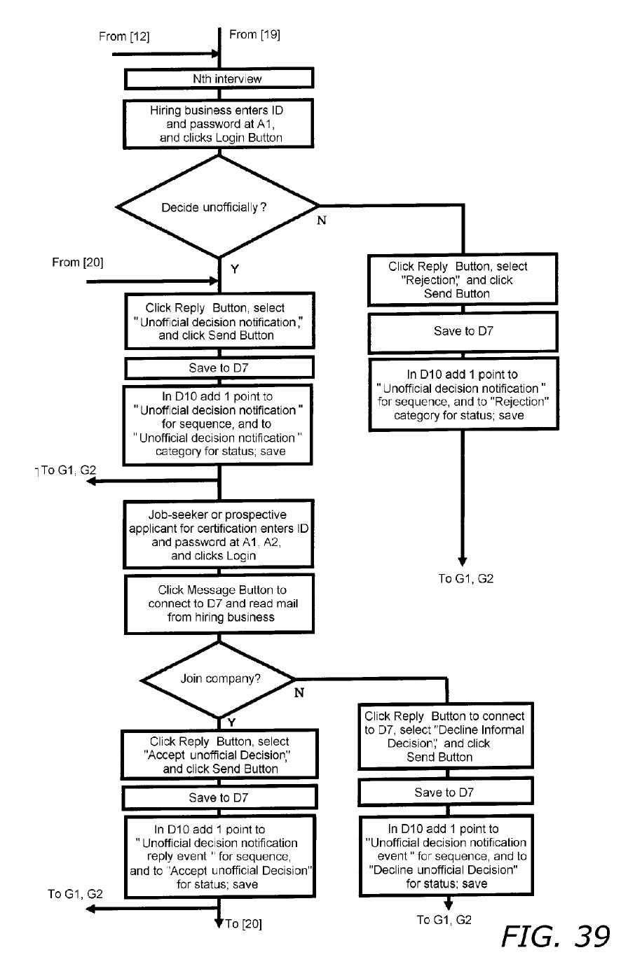

The above procedures of sending notice of unofficial decision by the hiring business are shown in the flowchart of FIG. 39.

(14) A job seeker/certification candidate accesses Interface A1, browsable by PC, or Interface A2, browsable by mobile terminal, of Interface 2 via Network 5 with PCA-D, enters an ID and password in the Enter Form, and clicks the Login Button to open My Page.

He/she then clicks the Message Button to connect to database D7 and reads emails sent by the hiring business.

If A job seeker/certification candidate receives a reply of “notice of unofficial decision,” and wants to join the company, he/she clicks the Reply Button and selects “accept unofficial decision.”

After clicking Send, control system B6 operates to save the data to database D7, and at the same time control system B8 operates to add and save in database D10 one point to “unofficial decision notification answer event” for the operational sequence and to “accept unofficial decision” for the operational status. This operation is reflected in Tables 1 and 2.

If a job seeker/certification candidate does not want to join the company, he/she clicks the Reply Button and selects “decline unofficial decision.”

After clicking Send, control system B6 operates to save the data to database D7, and at the same time control system B8 operates to add and save in database D10 one point to “unofficial decision notification answer event” for the operational sequence and to “decline unofficial decision” for the operational status. This operation is reflected in Tables 1 and 2.

The above procedures of replying to the notice of unofficial decision from the hiring business by job seekers/certification candidates are shown in the flowchart of FIG. 39.

(15) The hiring business accesses Interface A1 via Network 5 with PCF, enters an ID and password, and clicks the Login Button to open My Page.

In the case of receiving “acceptance of unofficial decision,” the hiring business clicks the Reply Button and selects “notice of appointment.”

After clicking Send, control system B6 operates to save the data to database D7, and at the same time control system B8 operates to add and save in database D10 one point to “notice of appointment” for the operational sequence and to “notice of appointment” for the operational status. This operation is reflected in Tables 1 and 2.

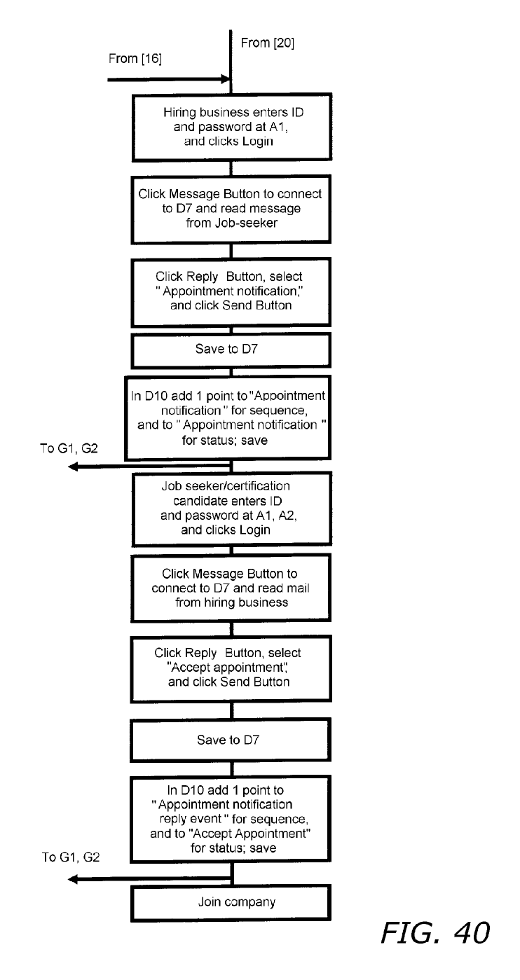

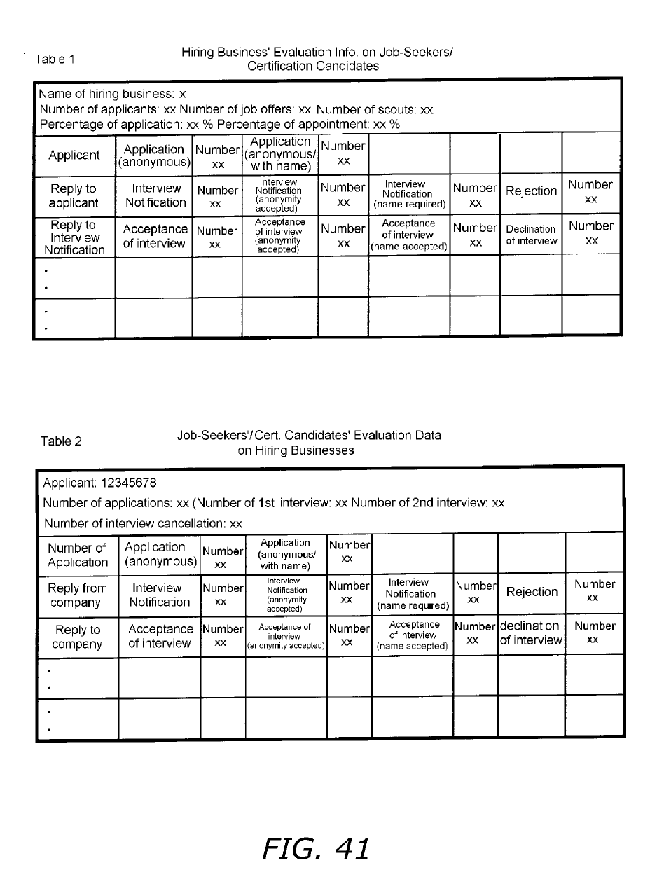

The above procedures of sending notice of appointment by the hiring business are shown in the flowchart of FIG. 40.

(16) A job seeker/certification candidate accesses Interface A1, browsable by PC, or Interface A2, browsable by mobile terminal, of Interface 2 via Network 5 with PCA-D, enters an ID and password in the Enter Form, and clicks the Login Button to open My Page.

He/she then clicks the Message Button to connect to database D7 and reads emails sent by the hiring business.

If a job seeker/certification candidate receives a reply of “notice of appointment,” he/she clicks the Reply Button and selects “accept appointment.”

After clicking Send, control system B6 operates to save the personal data to database D7, and at the same time control system B8 operates to add and save in database D10 one point to “appointment notification answer event” for the operational sequence and to “accept notice of appointment” for the operational status. This operation is reflected in Tables 1 and 2. He/she then joins the company.

The above procedures of replying to the hiring business by job seekers/certification candidates at the time of receiving acceptance of appointment from the hiring business are shown in the flowchart of FIG. 40.

These procedures are just examples; the name of each status and sequence and the numbers can be changed and increased or decreased.

### EMBODIMENT 5

Next, Embodiment 5 uses the general system of Embodiments 1 and 2. The hiring business accesses Interface 2 via Network 5, registers information regarding recruitment, courses, seminars, mock examinations, etc., selects information for posting at various sites, and clicks a button, placed in Interface 2, for posting at various sites. Then control system B7 automatically creates a file (File 1) for providing information regarding recruitment, courses, seminars, mock exams, etc., particular to the various sites, and saves it to Server 1, or connects to Server 1 to automatically create a file (File 2) in which a program of providing information regarding recruitment, courses, seminars, mock exams, etc. is written. File 1 is linked to various sites, and File 2 is saved to the various sites in order to provide information at the various sites.

A job seeker/professional certification candidate can apply and request brochures not only under his/her real name but also anonymously, and the hiring business can examine evaluations, from the standpoint of the hiring business, of A job seeker/certification candidate who applies and requests brochures.

Based on the result, the process of certain interviews, unofficial decisions, and joining the company is shown. In addition, an anonymous job seeker/certification candidate who applies for the position or requests brochures can reveal his/her real name at any point in the process mentioned above.

As stated above, the hiring business can provide information at its own site by registering the information at Server 1. Also, the system enables a job seeker/certification candidate to apply and request brochures not only under his/her real name but also anonymously without worrying about leaks of information when making an application or requesting brochures. Further, the system enables the hiring business, by browsing evaluation data, to examine whether the anonymous job seeker/certification candidate who applies and requests brochures really exists and really seeks a job or school.

(1) The hiring business accesses Interface A1, browsable by PC, of Interface 2 through Network 5 with PCF, and clicks the “For Corporate Client” button. Control system B2 then operates, and the Membership Form Page opens.

At this page, the hiring business enters the company's and administrator's data, and clicks the Register Button for Company's Information to operate control system B2; the data are then saved to database D3 and database D4. Next, an ID and password are created for each company and My Page is registered.

In addition, a URL linked to a file (File 1) for providing information about recruitment, courses, seminars, mock examinations, etc., of the particular hiring business is displayed. A URL linked to the file may be displayed after creating File 1 and File 2.

(2) The hiring business enters the ID and password at Interface A1, and clicks the Login button.

My Page then opens and the hiring business enters information about recruitment, courses, seminars, mock examinations, etc., and clicks the Register Button to operate control system B2; the data are saved to database D5 and to the database of information about seminars and information desired D6.

(3) In the case of providing information at its own site, the hiring business selects information about recruitment, courses, seminars, mock examinations, etc., for posting at its own site on the above-mentioned My Page, and selects “Posting at Own Site” at the Frame Purchase Page.

Next, if the hiring business uses any particular formats or designed pages, they are saved to Server 1. The unique page for the hiring business's own site may be created not only by the company itself, but also by a professional designer.

The hiring business then clicks a button for posting at various sites to operate control system B3, and the data are saved to database D5 and to the database of information about seminars and desired information D6.

At the same time, control system B7 operates to automatically create a file (File 1) for posting information regarding recruitment, courses, seminars, mock exams, etc., particular to the hiring business, and saves it to Server 1.

The control system B7 also connects to Server 1 to automatically create a file (File 2) in which a program for providing information regarding recruitment, courses, seminars, mock exams, etc., is written.

In the case that File 1 is used, a URL linked to File 1 and displayed when creating the ID and password of the hiring business is linked to the desired page of the hiring business's own site to post the information.

In the case that File 2 is used, the page is downloaded to be saved to the server of the hiring business's own site.

As stated above, information regarding recruitment, courses, seminars, mock exams, etc., designated as public information is displayed. There are a variety of programs for connecting to Server 1, and providing information, such as cgi, jsp, asp, html, XML, ActiveX, Java (registered trademark) applet, and Flash.

(4) A job seeker/certification candidate browses various sites 6 with PCA-D, selects a featured section for information regarding recruitment, courses, seminars, mock examinations, and so on, and browses the information.

Subsequently, in order to apply or request brochures, he/she clicks a button for applying and registering résumés and curriculum vitae.

After the Login Requirement Page opens, he/she enters desired IDs, passwords, and e-mail addresses.

He/she then clicks the Register Button for IDs, passwords, and e-mail addresses for job seekers/certification candidates, whereby the information is saved in database D2.

Next, the Application Form opens. He/she enters necessary items in the form, and clicks the Confirmation Button to save them to database D2.

If applying anonymously, the applicant selects “Apply (anonymously),” and clicks the Application Button.

The control system B2 and control system B6 operate to save résumés and curriculum vitae to database D2 and database D7, while at the same time control system B8 operates to add and save in database D10 one point to “response event” for the operational sequence and to “apply (anonymously)” for the operational status. This operation is reflected in Tables 1 and 2.

Next, in the case of registering personal data, he/she clicks the Register Button to open Login Requirement Page, and enters an ID and password which are different from ones registered at the time of registering résumés and curriculum vitae mentioned above. He/she then clicks the Save Button after entering personal data in the form. The data is saved to database D1.

If applying under his/her real name, the applicant selects “apply (with name),” and clicks the Application Button to operate control system B2 and control system B6 to save résumés and curriculum vitae to database D2 and database D7, while at the same time control system B8 operates to add and save in database D10 one point to “response event” for the operational sequence and to “apply (with name)” for the operational status.

Next, the Login Page for registering personal data opens, and the applicant enters an ID and password which are different from ones registered at the time of registering résumés and curriculum vitae mentioned above.

After entering personal data in the form and clicking the Send Button, control system B1 and control system B6 operate to save the personal data to database D1 and database D7. This operation is reflected in Tables 1 and 2.

The succeeding process leads to applying with a name as described above.

(6) The hiring business accesses Interface A1 via Network 5 with PCF, enters an ID and passwords, and clicks the Login Button to open My Page. It then clicks the Message button to connect database D7, and examines applications and requests for brochures.

When the hiring business wants to examine evaluation data of job seekers/certification candidates who have applied or requested brochures, it clicks the evaluation Button to output the evaluation data of job seekers/certification candidates for hiring business, Table 2. As a result, when the hiring business wants to give an interview to an applicant, the procedures vary depending on the situation of the application or request for brochures submitted by the job seeker/certification candidate.

First, in the case of an anonymous application by a job seeker/certification candidate, if the hiring business grants the anonymous interview, it clicks the Reply Button and selects “interview notification (anonymity accepted).”

After clicking Send, control system B6 operates to save the data to database D7, and at the same time control system B8 operates to add and save in database D10 one point to “application answer event” for the operational sequence and to “interview notification (anonymity accepted)” for the operational status. This operation is reflected in Tables 1 and 2.

In the case of disallowing an anonymous interview, the hiring business clicks the Reply Button and selects “interview notification (name required).”

After clicking Send, control system B6 operates to save the data to database D7, and at the same time control system B8 operates to add and save in database D10 one point to “application answer event” for the operational sequence and to “interview notification (name required)” for the operational status. This operation is reflected in Tables 1 and 2.

In the case of rejecting an interview, the hiring business clicks the Reply Button and selects “rejection.”

After clicking Send, control system B6 operates to save the data to database D7, and at the same time control system B8 operates to add and save in database D10 one point to “application answer event” for the operational sequence and to “rejection” for the operational status. This operation is reflected in Tables 1 and 2.

(7) A job seeker/certification candidate accesses Interface A1, browsable by PC, or Interface A2, browsable by mobile terminal, of Interface 2 via Network 5 with PCA-D, enters an ID and password in the Enter Form, and clicks the Login Button to open My Page.

He/she then clicks the Message Button to connect to database D7 and reads emails sent by the hiring business.

If a job seeker/certification candidate receives a reply of “interview notification (anonymity accepted)” and wants to have an interview, he/she clicks the Reply Button and selects “accept Interview (anonymity accepted).”

After clicking Send, control system B6 operates to save the data to database D7, and at the same time control system B8 operates to add and save in database D10 one point to “interview notification answer event” for the operational sequence and to “accept interview (anonymity accepted)” for the operational status. This operation is reflected in Tables 1 and 2.

If a job seeker/certification candidate receives a reply of “interview notification (name required)” and chooses to disclose the personal data, he/she clicks the Reply Button and selects “accept Interview (name accepted).”

Next, after entering an ID and password for registering personal data, the personal data opens; then the applicant confirms the data and clicks the Send Button to operate control system B6 to save the personal data to database D7, and at the same time control system B8 operates to add and save in database D10 one point to “interview notification answer event” for the operational sequence and to “accept interview (name accepted)” for the operational status. This operation is reflected in Tables 1 and 2.

If a job seeker/certification candidate receives a reply of “interview notification (anonymity accepted)” and does not want to have the interview, or if the job seeker/certification candidate receives a reply of “interview notification (name required)” and does not choose to disclose the personal data, he/she clicks the Reply Button and selects “decline Interview.”

After clicking Send, control system B6 operates to save the data to database D7, and at the same time control system B8 operates to add and save in database D10 one point to “interview notification answer event” for the operational sequence and to “decline Interview” for the operational status. This operation is reflected in Tables 1 and 2.

(8) The hiring business accesses Interface A1 via Network 5 with PCF, enters an ID and password, and clicks the Login Button to open My Page.

In the case of giving the Nth interview and accepting anonymous interview, the hiring business clicks the Reply Button and selects “notice of Nth Interview (anonymity accepted).”

After clicking Send, control system B6 operates to save the data to database D7, and at the same time control system B8 operates to add and save in database D10 one point to “notice of Nth interview” for the operational sequence and to “notice of Nth interview (anonymity accepted)” for the operational status. This operation is reflected in Tables 1 and 2.

In the case of disallowing an anonymous interview, the hiring business clicks the Reply Button and selects “notice of the Nth Interview (name required).”

After clicking Send, control system B6 operates to save the data to database D7, and at the same time control system B8 operates to and save in database D10 one point to “notice of Nth interview” for the operational sequence and to “notice of Nth interview (name required)” for the operational status. This operation is reflected in Tables 1 and 2.

On the other hand, in case of rejecting without the Nth interview, the hiring business clicks the Reply Button and selects “rejection.” After clicking Send, control system B6 operates to save the data to database D7, and at the same time control system B8 operates to add and save in database D10 one point to “notice of Nth interview” for the operational sequence and to “rejection” for the operational status.

In the case of unofficially deciding to hire without the Nth interview, the process goes to the procedures for unofficial decisions. This operation is reflected in Tables 1 and 2.

(9) A job seeker/certification candidate accesses Interface A1, browsable by PC, or Interface A2, browsable by mobile terminal, of Interface 2 via Network 5 with PCA-D, enters an ID and password in the Enter Form, and clicks the Login Button to open My Page.

He/she then clicks the Message Button to connect to database D7 and reads emails sent by the hiring business.

If a job seeker/certification candidate receives a reply of “notice of the Nth Interview (anonymity accepted)” and wants to have an interview, he/she clicks the Reply Button and selects “accept the Nth interview (anonymity accepted).”

After clicking Send, control system B6 operates to save the data to database D7, and at the same time control system B8 operates to add and save in database D10 one point to “Nth interview notification answer event” for the operational sequence and to “accept the Nth interview (anonymity accepted)” for the operational status. This operation is reflected in Tables 1 and 2. If a job seeker/certification candidate receives a reply of “notice of the Nth Interview (name required)” and chooses to disclose the personal data, he/she clicks the Reply Button and selects “accept the Nth interview (name accepted).”

Next, after entering an ID and password for registering personal data, the personal data opens; then the applicant confirms the data and clicks the Send Button to operate control system B6 to save the personal data to database D7, and at the same time control system B8 operates to add and save in database D10 one point to “Nth interview notification answer event” for the operational sequence and to “accept the Nth interview (name accepted)” for the operational status. This operation is reflected in Tables 1 and 2. The succeeding process leads to applying with a name as described later.

If a job seeker/certification candidate receives a reply of “notice of the Nth Interview (anonymity accepted)” and does not want to have the interview, or if the job seeker/certification candidate receives a reply of “notice of the Nth Interview (name required)” and does not choose to disclose the personal data, he/she clicks the Reply Button and selects “decline the Nth interview.”

After clicking Send, control system B6 operates to save the data to database D7, and at the same time control system B8 operates to add and save in database D10 one point to “Nth interview notification answer event” for the operational sequence and to “decline Nth interview” for the operational status. This operation is reflected in Tables 1 and 2.

(10) The hiring business accesses Interface A1 via Network 5 with PCF, enters an ID and password, and clicks the Login Button to open My Page.

In the case of unofficially deciding to hire and accept anonymity, the hiring business clicks the Reply Button and selects “notice of unofficial decision (anonymity accepted).”

After clicking Send, control system B6 operates to save the data to database D7, and at the same time control system B8 operates to add and save in database D10 one point to “notice of unofficial decision” for the operational sequence and to “notice of unofficial decision (anonymity accepted)” for the operational status. This operation is reflected in Tables 1 and 2.

In the case of disallowing the anonymity for the Unofficial decision, the hiring business clicks the Reply Button and selects “interview notification (name required).”

After clicking Send, control system B6 operates to save the data to database D7, and at the same time control system B8 operates to add and save in database D10 one point to “notice of unofficial decision” for the operational sequence and to “notice of unofficial decision (name required)” for the operational status. This operation is reflected in Tables 1 and 2.

On the other hand, in case of disallowing an unofficial decision, the hiring business clicks the Reply Button and selects “rejection.”

After clicking Send, control system B6 operates to save the data to database D7, and at the same time control system B8 operates to add and save in database D10 one point to “notice of unofficial decision” for the operational sequence and to “rejection” for the operational status. This operation is reflected in Tables 1 and 2.

(11) A job seeker/certification candidate accesses Interface A1, browsable by PC, or Interface A2, browsable by mobile terminal, of Interface 2 via Network 5 with PCA-D, enters an ID and password in the Enter Form, and clicks the Login Button to open My Page.

He/she then clicks the Message Button to connect to database D7 and reads emails sent by the hiring business.

If a job seeker/certification candidate receives a reply of “notice of unofficial decision (anonymity accepted),” and wants to join the company, he/she clicks the Reply Button and selects “accept unofficial decision (anonymity accepted).”

After clicking Send, control system B6 operates to save the data to database D7, and at the same time control system B8 operates to add and save in database D10 one point to “unofficial decision notification answer event” for the operational sequence and to “accept unofficial decision (anonymity accepted)” for the operational status. This operation is reflected in Tables 1 and 2.

If a job seeker/certification candidate receives a reply of “notice of unofficial decision (name required)” and chooses to disclose the personal data, he/she clicks the Reply Button and selects “accept unofficial decision (name required).”

Next, after entering an ID and password for registering personal data, the personal data opens; then the applicant confirms the data and clicks the Send Button to operate control system B6 to save the personal data to database D7, and at the same time control system B8 operates to add and save in database D10 one point to “unofficial decision notification answer event” for the operational sequence and to “accept unofficial decision (name accepted)” for the operational status. This operation is reflected in Tables 1 and 2.

The succeeding process leads to applying with a name as described above.

If a job seeker/certification candidate receives a reply of “notice of unofficial decision (anonymity accepted)” and does not want to join the company, or if the job seeker/certification candidate receives a reply of “notice of unofficial decision (name required)” and does not choose to disclose the personal data, he/she clicks the Reply Button and selects “decline unofficial decision.”

After clicking Send, control system B6 operates to save the data to database D7, and at the same time control system B8 operates to add and save in database D10 one point to “unofficial decision notification answer event” for the operational sequence and to “decline unofficial decision” for the operational status. This operation is reflected in Tables 1 and 2.

(12) The hiring business accesses Interface A1 via Network 5 with PCF, enters an ID and password, and clicks the Login Button to open My Page.

In the case of receiving “notice of unofficial decision (anonymity accepted),” the hiring business clicks the Reply Button and selects “notice of appointment (name required).” After clicking Send, control system B6 operates to save the data to database D7, and at the same time control system B8 operates to add and save in database D10 one point to “notice of appointment” for the operational sequence and to “notice of appointment (name required)” for the operational status. This operation is reflected in Tables 1 and 2.

(13) A job seeker/certification candidate accesses Interface A1, browsable by PC, or Interface A2, browsable by mobile terminal, of Interface 2 via Network 5 with PCA-D, enters an ID and password in the Enter Form, and clicks the Login Button to open My Page.

He/she then clicks the Message Button to connect to database D7 and reads emails sent by the hiring business.

If a job seeker/certification candidate receives a reply of “notice of appointment (name required)” and chooses to disclose the personal data, he/she clicks the Reply Button and selects “accept appointment (name accepted).” Next, after entering an ID and password for registering personal data, the personal data opens; then the applicant confirms the data and clicks the Send Button to operate control system B6 to save the personal data to database D7, and at the same time control system B8 operates to add and save in database D10 one point to “appointment notification answer event” for the operational sequence and to “accept notice of appointment (name required)” for the operational status. This operation is reflected in Tables 1 and 2. He/she then joins the company.

If a job seeker/certification candidate receives a reply of “notice of appointment (name required)” and does not choose to disclose the personal data, he/she clicks the Reply Button and selects “decline appointment.”

After clicking Send, control system B6 operates to save the data to database D7, and at the same time control system B8 operates to add and save in database D10 one point to “appointment notification answer event” for the operational sequence and to “decline appointment” for the operational status. This operation is reflected in Tables 1 and 2.

(14) The process of applying using a real name is as follows.

The hiring business accesses Interface A1 via Network 5 with PCF, enters an ID and password, and clicks the Login Button to open My Page.

The hiring business then clicks the Message Button to connect to database D7, and examines applications and requests for brochures.

When the hiring business wants to examine evaluation data of job seekers/certification candidates who have applied or requested brochures, it clicks the Evaluation Button to output the evaluation data of job seekers/certification candidates for hiring business Table 2.

When the hiring business decides to give an interview to the applicant, it clicks the Reply Button and selects “interview notification.”

After clicking Send, control system B6 operates to save the data to database D7, and at the same time control system B8 operates to add and save in database D10 one point to “application answer event” for the operational sequence and to “interview notification” for the operational status. This operation is reflected in Tables 1 and 2.

In the case of rejecting an interview, the hiring business clicks the Reply Button and selects “rejection.” After clicking Send, control system B6 operates to save the data to database D7, and at the same time control system B8 operates to add and save in database D10 one point to “application answer event” for the operational sequence and to “rejection” for the operational status. This operation is reflected in Tables 1 and 2.

(15) A job seeker/certification candidate accesses Interface A1, browsable by PC, or Interface A2, browsable by mobile terminal, of Interface 2 via Network 5 with PCA-D, enters an ID and password in the Enter Form, and clicks the Login Button to open My Page.

He/she then clicks the Message Button to connect to database D7 and reads emails sent by the hiring business.

If a job seeker/certification candidate receives a reply of “interview notification” and wants to have an interview, he/she clicks the Reply Button and selects “accept Interview.”

After clicking Send, control system B6 operates to save the data to database D7, and at the same time control system B8 operates to add and save in database D10 one point to “interview notification answer event” for the operational sequence and to “accept interview” for the operational status. This operation is reflected in Tables 1 and 2.

If a job seeker/certification candidate receives a reply of “interview notification” and does not want to have the interview, he/she clicks the Reply Button and selects “decline Interview.”

After clicking Send, control system B6 operates to save the data to database D7, and at the same time control system B8 operates to and save in database D10 one point to “interview notification answer event” for the operational sequence and to “decline interview” for the operational status. This operation is reflected in Tables 1 and 2.

(16) The hiring business accesses Interface A1 via Network 5 with PCF, enters an ID and password, and clicks the Login Button to open My Page.

In the case of giving the Nth interview, the hiring business clicks the Reply Button and selects “notice of Nth Interview.”

After clicking Send, control system B6 operates to save the data to database D7, and at the same time control system B8 operates to add and save in database D10 one point to “notice of Nth interview” for the operational sequence and to “notice of Nth interview” for the operational status. This operation is reflected in Tables 1 and 2.

In the case of rejecting without the Nth interview, the hiring business clicks the Reply Button and selects “rejection.”

After clicking Send, control system B6 operates to save the data to database D7, and at the same time control system B8 operates to add and save in database D10 one point to “notice of Nth interview” for the operational sequence and to “rejection” for the operational status.

In the case of unofficially deciding to hire without the Nth interview, the process goes to the procedures for unofficial decisions. This operation is reflected in Tables 1 and 2.

(17) A job seeker/certification candidate accesses Interface A1, browsable by PC, or Interface A2, browsable by mobile terminal, of Interface 2 via Network 5 with PCA-D, enters an ID and password in the Enter Form, and clicks the Login Button to open My Page.

He/she then clicks the Message Button to connect to database D7 and reads emails sent by the hiring business.

If a job seeker/certification candidate receives a reply of “notice of the Nth Interview” and wants to have an interview, he/she clicks the Reply Button and selects “accept the Nth interview.”

After clicking Send, control system B6 operates to save the data to database D7, and at the same time control system B8 operates to add and save in database D10 one point to “Nth interview notification answer event” for the operational sequence and to “accept the Nth interview” for the operational status. This operation is reflected in Tables 1 and 2.

If a job seeker/certification candidate does not want to have the interview, he/she clicks the Reply Button and selects “decline the Nth interview.”

After clicking Send, control system B6 operates to save the data to database D7, and at the same time control system B8 operates to add and save in database D10 one point to “Nth interview notification answer event” for the operational sequence and to “decline the Nth interview” for the operational status. This operation is reflected in Tables 1 and 2.

(8) The hiring business accesses Interface A1 via Network 5 with PCF, enters an ID and password, and clicks the Login Button to open My Page.

In the case of unofficially deciding to hire, the hiring business clicks the Reply Button and selects “notice of unofficial decision.”

After clicking Send, control system B6 operates to save the data to database D7, and at the same time control system B8 operates to and save in database D10 one point to “notice of unofficial decision” for the operational sequence and to “notice of unofficial decision” for the operational status. This operation is reflected in Tables 1 and 2.

In the case of disallowing an unofficial decision, the hiring business clicks the Reply Button and selects “rejection.”

After clicking Send, control system B6 operates to save the data to database D7, and at the same time control system B8 operates to add and save in database D10 one point to “notice of unofficial decision” for the operational sequence and to “rejection” for the operational status. This operation is reflected in Tables 1 and 2.

(19) A job seeker/certification candidate accesses Interface A1, browsable by PC, or Interface A2, browsable by mobile terminal, of Interface 2 via Network 5 with PCA-D, enters an ID and password in the Enter Form, and clicks the Login Button to open My Page.

He/she then clicks the Message Button to connect to database D7 and reads emails sent by the hiring business.

If a job seeker/certification candidate receives a reply of “notice of unofficial decision,” and wants to join the company, he/she clicks the Reply Button and selects “accept unofficial decision.”

After clicking Send, control system B6 operates to save the data to database D7, and at the same time control system B8 operates to add and save in database D10 one point to “unofficial decision notification answer event” for the operational sequence and to “accept unofficial decision” for the operational status. This operation is reflected in Tables 1 and 2.

If a job seeker/certification candidate does not want to join the company, he/she clicks the Reply Button and selects “decline unofficial decision.”

After clicking Send, control system B6 operates to save the data to database D7, and at the same time control system B8 operates to add and save in database D10 one point to “unofficial decision notification answer event” for the operational sequence and to “decline unofficial decision” for the operational status. This operation is reflected in Tables 1 and 2.

(20) The hiring business accesses Interface A1 via Network 5 with PCF, enters an ID and password, and clicks the Login Button to open My Page.

In the case of receiving “acceptance of unofficial decision,” the hiring business clicks the Reply Button and selects “notice of appointment.”

After clicking Send, control system B6 operates to save the data to database D7, and at the same time control system B8 operates to add and save in database D10 one point to “notice of appointment” for the operational sequence and to “notice of appointment” for the operational status. This operation is reflected in Tables 1 and 2.

(21) A job seeker/certification candidate accesses Interface A1, browsable by PC, or Interface A2, browsable by mobile terminal, of Interface 2 via Network 5 with PCA-D, enters an ID and password in the Enter Form, and clicks the Login Button to open My Page.

He/she then clicks the Message Button to connect to database D7 and reads emails sent by the hiring business.

If a job seeker/certification candidate receives a reply of “notice of appointment,” he/she clicks the Reply Button and selects “accept appointment.

After clicking Send, control system B6 operates to save the data to database D7, and at the same time control system B8 operates to add and save in database D10 one point to “appointment notification answer event” for the operational sequence and to “accept notice of appointment” for the operational status. This operation is reflected in Tables 1 and 2. The applicant then joins the company.

These procedures are just examples; the name of each status and sequence and the numbers can be changed and increased or decreased.

The system of the present invention has the following advantages by setting up web pages as interfaces open to a network not only in Server 1 but also in a plurality of various sites 6 (S1-S4). (1) Many more job seekers/certification candidates and recruiting companies can use the web pages in the various sites rather than using only the web pages of Server 1. (2) The frequency of browsing the web pages becomes greater because the various sites 6 (S1-S4) also have featured sections to invite users. (3) Job seekers/certification candidates can gain necessary information anonymously and can apply for positions anonymously. In addition, (4) Job seekers/certification candidates can request brochures and apply for courses without worrying about leaks of personal data because there are two different databases, one including personal data and one with résumés, curriculum vitae, etc., of job seekers/certification candidates.

Only selected embodiments have been chosen to illustrate the present invention. To those skilled in the art, however, it will be apparent from the foregoing disclosure that various changes and modifications can be made herein without departing from the scope of the invention as defined in the appended claims. The foregoing description of the embodiments according to the present invention is provided for illustration only, and not for limiting the invention as defined by the appended claims and their equivalents.

1. A system for evaluating anonymous information while providing information about job offers and recruiting and other related information through network; in which the sites devoted to positions/help wanted information is set up by a server connected to the network; in which the server has interface, control system, and database; in which the interface is open to the network, and comprised of webpages browsable by personal computer, mobile terminal, etc.; in which the webpages post necessary information about job offers and recruiting, improving career and skill, etc., and have various registration buttons, etc.; in which a hiring business provides information about recruiting at the sites devoted to positions/help wanted information; in which job seekers/certification candidates enter anonymous information about job-seeking and applying for certification at the sites devoted to positions/help wanted information, and if the applicants find favorable information about recruiting and applying for certification, applying for the hiring business and having interviews anonymously are available using an application system; in which logs of applications, interviews, etc. done by job seekers/certification candidates and various notices sent by recruiting companies are automatically calculated and displayed at the sites devoted to positions/help wanted information; in which recruiting companies browse anonymous job seekers/certification candidates, and conclude their skill, and evaluate the anonymous information of anonymous job seekers/certification candidates based on said calculation data.

2. A system for evaluating anonymous information while providing information about job offers and recruiting and other related information through network; in which the sites devoted to positions/help wanted information is set up by a server connected to the network; in which the server has interface, control system, and database; in which the interface is open to the network, and comprised of webpages browsable by personal computer, mobile terminal, etc.; in which the webpages post necessary information about job offers and recruiting, improving career and skill, etc., and have various registration buttons, etc.; and in which various sites are provided the same information as the server provides by said control system posting information posted at the interface of the server; in which a hiring business enters information about recruiting at the sites devoted to positions/help wanted information, and also provides information about recruiting at various sites; in which job seekers/certification candidates enter anonymous information about recruiting and applying for certification at the sites devoted to positions/help wanted information and various sites, and if the applicants find favorable information about job-seeking and applying for certification, anonymous application for the hiring business and request brochures are available using an application system; in which logs of applications, interviews, etc. done by job seekers/certification candidates and various notices sent by recruiting companies are automatically calculated and displayed at the sites devoted to positions/help wanted information and also at various sites; in which recruiting companies browse anonymous job seekers/certification candidates, and conclude their skill, and evaluate the anonymous information of anonymous job seekers/certification candidates based on said calculation data.

3. In claim 1, a system for evaluating anonymous information while providing information about job offers and recruiting and other related information through network is characterized in that recruiting companies browse anonymous job seekers/certification candidates, and conclude their skill, and evaluate the anonymous information of anonymous job seekers/certification candidates based on said calculation data so as to send scout emails, and logs of applications, interviews, etc. done by job seekers/certification candidates and various notices sent by recruiting companies are automatically calculated and displayed at the sites devoted to positions/help wanted information so as to evaluate more anonymous information about anonymous job seekers/certification candidates.

4. In claim 2, a system for evaluating anonymous information while providing information about job offers and recruiting and other related information through network is characterized in that recruiting companies browse anonymous job seekers/certification candidates, and conclude their skill, and evaluate the anonymous information of anonymous job seekers/certification candidates based on said calculation data so as to send scout emails, and logs of applications, interviews, etc. done by job seekers/certification candidates and various notices sent by recruiting companies are automatically calculated and displayed at the sites devoted to positions/help wanted information so as to evaluate more anonymous information about anonymous job seekers/certification candidates.

5. In claim 1, a system for evaluating anonymous information while providing information about job offers and recruiting and other related information through network is characterized in that the database of the sites devoted to positions/help wanted information has two databases including a database of personal data of job seekers/certification candidates and IDs, password and e-mail addresses for the personal data and a database of résumés, curriculum vitae, and information desired of job seekers/certification candidates and different ID and password from ID and password of the personal data.

6. In claim 2, a system for evaluating anonymous information while providing information about job offers and recruiting and other related information through network is characterized in that the database of the sites devoted to positions/help wanted information has two databases including a database of personal data of job seekers/certification candidates and IDs, password and e-mail addresses for the personal data and a database of résumés, curriculum vitae, and information desired of job seekers/certification candidates and different ID and password from ID and password of the personal data.

7. In claim 3, a system for evaluating anonymous information while providing information about job offers and recruiting and other related information through network is characterized in that the database of the sites devoted to positions/help wanted information has two databases including a database of personal data of job seekers/certification candidates and IDs, password and e-mail addresses for the personal data and a database of résumés, curriculum vitae, and information desired of job seekers/certification candidates and different ID and password from ID and password of the personal data.

8. In claim 4, a system for evaluating anonymous information while providing information about job offers and recruiting and other related information through network is characterized in that the database of the sites devoted to positions/help wanted information has two databases including a database of personal data of job seekers/certification candidates and IDs, password and e-mail addresses for the personal data and a database of résumés, curriculum vitae, and information desired of job seekers/certification candidates and different ID and password from ID and password of the personal data.
